(19) United States
(12) Patent Application Publication
(10) Pub. No.: US 2019/0070957 A1
(43) Pub. Date: Mar. 7, 2019

(54) Driving Assistance Device And Driving Assistance Method

(71) Applicant: HONDA MOTOR CO., LTD., Tokyo (JP)

(72) Inventors: Masayuki NAKATSUKA, Haga-gun (JP); John J. SCALLY, Plain City, OH (US); Jiro KURITA, Dublin, OH (US); Hiroyuki KOIBUCHI, Haga-gun (JP); Yukinori KURAHASHI, Haga-gun (JP)

(21) Appl. No.: 15/693,648

(22) Filed: Sep. 1, 2017

(51) Int. Cl. B60K 28/06; B60K 35/00; B60W 10/20; B60W 10/18; B60W 40/08; B60W 30/12; B60W 50/14; B60W 50/12

(52) U.S. Cl. CPC B60K 28/06; B60W 2050/146; B60W 10/20; B60W 10/18; B60W 40/08; B60W 30/12; B60W 50/14; B60W 50/12; B60K 2350/1032; B60W 2040/0818; B60W 2540/26; B60W 2710/20; B60W 2710/182; B60W 2420/42; B60K 35/00

(57) ABSTRACT

A driving assistance device and a driving assistance method capable of decelerating a vehicle in the event of an emergency while suppressing erroneous operations of an occupant are provided. A driving assistance device may include a first switch configured to receive an operation of an occupant, a second switch configured to receive an operation of the occupant after the first switch receives an operation of the occupant, a storage configured to store information, and a processor configured to execute a program stored in the storage, wherein the storage stores the program that causes the processor to execute, a process of decelerating a vehicle until the speed of the vehicle becomes smaller than a predetermined speed when the second switch receives an operation of the occupant.

### FIELD

The present invention relates to a driving assistance device and a driving assistance method.

### BACKGROUND

Conventionally, an advanced vehicle driver support system that executes one or more driver support functions is known (see Japanese Unexamined Patent Application, First Publication No. 2016-115023). This system includes an environment sensor that detects the environment around a vehicle, a driver state monitor that monitors a driver to determine an abnormal state of the driver, an activation switch which can be operated by the driver and can activate or stop a driver support function, and a driver support controller that executes one or more driver support functions in order to control the vehicle according to target behavior determined on the basis of the environment around the vehicle. The driver support controller activates the driver support function when an abnormal state of the driver is detected by the driver state monitor in a state in which the activation switch is set to stop.

In recent years, an autonomous emergency stop system that automatically stops a vehicle when a driver becomes ill or the like has been proposed. However, in the conventional technology, the autonomous stop control may be performed easily even when the system is erroneously operated by an occupant.

### SUMMARY OF THE INVENTION

One aspect of the present invention provides a driving assistance device and a driving assistance method capable of decelerating a vehicle in the event of an emergency while suppressing erroneous operations of an occupant.

(1) A driving assistance device may include a first switch configured to receive an operation of an occupant, a second switch configured to receive an operation of the occupant after the first switch receives an operation of the occupant, a storage configured to store information, and a processor configured to execute a program stored in the storage, wherein the storage stores the program that causes the processor to execute, a process of decelerating a vehicle until the speed of the vehicle becomes smaller than a predetermined speed when the second switch receives an operation of the occupant.

(2) In the driving assistance device of (1), the second switch is further configured to not receive an operation of the occupant until a predetermined period has elapsed after the first switch receives an operation of the occupant and receive an operation of the occupant after the predetermined period has elapsed.

(3) The driving assistance device of (1) or (2) further includes a touch panel configured to display information, wherein the storage stores the program that further causes the processor to execute, a process of causing the touch panel to display information on the vehicle, and a process of causing the touch panel to display the second switch in a state in which the switch can receive an operation.

(4) In the driving assistance device of (3), the storage stores the program that further causes the processor to execute, a process of causing the touch panel to display the second switch in a state in which the switch cannot receive an operation until a predetermined period has elapsed after the first switch receives an operation of the occupant.

(5) The driving assistance device of (1) or (2) further includes a display configured to display information, wherein the storage stores the program that further causes the processor to execute, a process of causing the display to display information on the vehicle, a process of causing the display to display information indicating that the second switch has entered into a state in which the switch can receive an operation after the first switch receives an operation of the occupant.

(6) In the driving assistance device of any one of (1) to (5), the storage stores the program that further causes the processor to execute, a process of decelerating the vehicle when the first switch receives an operation of the occupant.

(7) In the driving assistance device of (6), a braking force applied to the vehicle associated with the process of decelerating the vehicle executed by the processor when the first switch receives an operation of the occupant is smaller than a braking force applied to the vehicle associated with the process of decelerating the vehicle executed by the processor when the second switch receives an operation of the occupant.

(8) The driving assistance device of any one of (1) to (7) further includes a third switch configured to not receive an operation of the occupant before the second switch receives an operation of the occupant and receive an operation of the occupant after the second switch receives an operation of the occupant, wherein the storage stores the program that further causes the processor to stop execution of a process of decelerating the vehicle when the third switch receives an operation of the occupant.

(9) In the driving assistance device of any one of (1) to (8), the storage stores the program that further causes the processor to execute, a process of starting steering control of controlling steering of the vehicle so as to maintain a traveling lane when the first switch receives an operation of the occupant, and a process of continuing the steering control even after the second switch receives an operation of the occupant.

(10) In the driving assistance device of any one of (1) to (9), the storage stores the program that further causes the processor to execute, a process of starting steering control of controlling steering of the vehicle so as not to depart a traveling lane when the first switch receives an operation of the occupant, and a process of continuing the steering control even after the second switch receives an operation of the occupant.

(11) The driving assistance device of any one of (1) to (10) further includes a fourth switch configured to receive an operation of the occupant, a braking mechanism that applies a braking force for stopping the vehicle to the vehicle, and an actuator configured to drive the brake mechanism when the fourth switch receives an operation of the occupant, wherein the storage stores the program that further causes the processor to execute, a process of decelerating the vehicle until the speed of the vehicle becomes smaller than the predetermined speed when the speed of the vehicle is equal to or larger than the predetermined speed and the fourth switch receives an operation of the occupant.

(12) The driving assistance device of (11) further includes a camera configured to capture an image of the occupant, wherein the storage stores the program that further causes the processor to execute, a process of determining whether the occupant is in a predetermined state on the basis of the image generated by the camera, and a process of decelerating the vehicle until the speed of the vehicle becomes smaller than the predetermined speed when the occupant is in the predetermined state, the speed of the vehicle is equal to or larger than the predetermined speed, and the fourth switch receives an operation of the occupant.

(13) The driving assistance device of any one of (1) to (12) further includes a camera configured to capture an image of the occupant, wherein the storage stores the program that further causes the processor to execute, a process of determining whether the occupant is in a predetermined state on the basis of the image generated by the camera, and a process of decelerating the vehicle until the speed of the vehicle becomes smaller than the predetermined speed when the occupant is in the predetermined state.

(14) A driving assistance method for causing a computer mounted in a vehicle including a first switch configured to receive an operation of an occupant, a second switch configured to receive an operation of the occupant after the first switch receives an operation of the occupant, and a storage configured to store information to execute, a process of decelerating the vehicle until the speed of the vehicle becomes smaller than a predetermined speed when the second switch receives an operation of the occupant.

According to (1) to (14), it is possible to decelerate a vehicle in the event of an emergency while suppressing erroneous operations of an occupant.

### BRIEF DESCRIPTION OF THE DRAWINGS

FIG. 1 is a diagram showing an example of a configuration of a vehicle on which a driving assistance device according to a first embodiment is mounted.

FIG. 2 is a diagram illustrating an example of an installation position of a touch panel.

FIG. 3 is a diagram illustrating an example of an installation position of a primary switch.

FIG. 4 is a diagram illustrating an example of a screen displayed on a touch panel after a primary switch is operated.

FIG. 5 is a diagram illustrating an example of a screen displayed on a touch panel after a predetermined period has elapsed.

FIG. 6 is a diagram illustrating an example of a screen displayed on a touch panel after an operation start switch is operated.

FIG. 7 is a diagram illustrating an example of a screen displayed on a touch panel when an operation start switch and an operation cancel switch are mechanical switches.

FIG. 8 is a diagram illustrating another example of a screen displayed on a touch panel when an operation start switch and an operation cancel switch are mechanical switches.

FIG. 9 is a diagram illustrating how the relative position and the attitude of a subject vehicle in relation to a traveling lane are recognized by a lane recognition component.

FIG. 10 is a diagram illustrating an example of the relationship between a reaction force and the relative position of a subject vehicle in relation to a subject lane.

FIG. 11 is a diagram describing the timings of respective controls by a driving assistance device.

FIG. 12 is a diagram describing the timings of respective controls by a driving assistance device.

FIG. 13 is a diagram describing the timings of respective controls by a driving assistance device.

FIG. 14 is a diagram describing the timings of respective controls by a driving assistance device.

FIG. 15 is a diagram describing the timings of respective controls by a driving assistance device.

FIG. 16 is a flowchart illustrating the flow of a series of processes executed by a driving assistance device according to a first embodiment.

FIG. 17 is a flowchart illustrating the flow of a series of processes executed by a driving assistance device according to a first embodiment.

FIG. 18 is a diagram describing the timings of respective controls by a driving assistance device.

FIG. 19 is a diagram illustrating an example of a configuration of a subject vehicle on which a driving assistance device according to a second embodiment is mounted.

FIG. 20 is a flowchart illustrating the flow of a series of processes executed by a driving assistance device according to a second embodiment.

FIG. 21 is a flowchart illustrating the flow of a series of processes executed by a driving assistance device according to a second embodiment.

FIG. 22 is a diagram illustrating an example of a hardware configuration of a driving assistance device according to an embodiment.

### DETAILED DESCRIPTION

Hereinafter, an embodiment of a driving assistance device and a driving assistance method according to the present invention will be described with reference to the drawings.

### First Embodiment

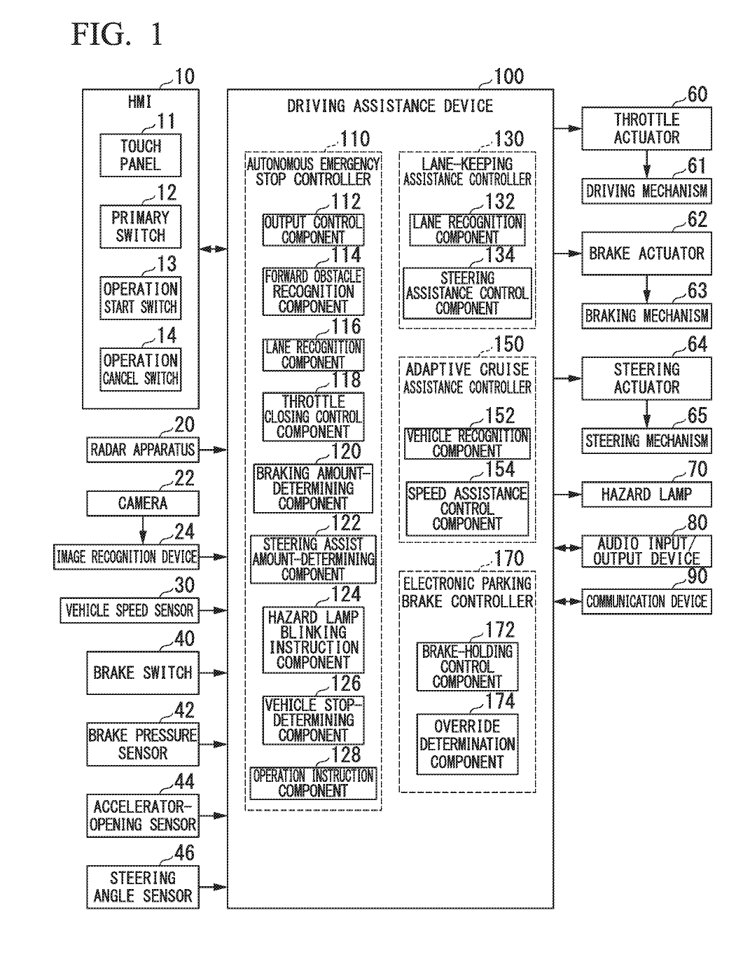

FIG. 1 is a diagram illustrating an example of a configuration of a vehicle (hereinafter a subject vehicle) on which a driving assistance device 100 according to a first embodiment is mounted. The driving assistance device 100 is connected to a human machine interface (HMI) 10, a radar apparatus 20, a camera 22, an image recognition device 24, a vehicle speed sensor 30, a brake switch 40, a brake pressure sensor 42, an accelerator-opening sensor 44, and a steering angle sensor 46. The driving assistance device 100 is also connected to a throttle actuator 60, a driving mechanism 61, a brake actuator 62, a braking mechanism 63, a steering actuator 64, a steering mechanism 65, a hazard lamp 70, an audio input/output device 80, and a communication device 90.

The driving assistance device 100 includes, for example, an autonomous emergency stop controller 110, a lane-keeping assistance controller 130, an adaptive cruise assistance controller 150, and an electronic parking brake controller 170. These components are realized when a hardware processor such as a central processing unit (CPU) executes a program (software). Some or all of these components may be realized by hardware (including circuitry) such as a large-scale integration (LSI) circuit, an application specific integrated circuit (ASIC), a field-programmable gate array (FPGA), or a graphics-processing unit (GPU) and may be realized by cooperation of software and hardware. Moreover, the autonomous emergency stop controller 110, the lane-keeping assistance controller 130, the adaptive cruise assistance controller 150, and the electronic parking brake controller 170 may be realized by one processor or a plurality of processors. In the latter case, the driving assistance device 100 may be a system in which a plurality of electronic control units (ECUs) are incorporated.

The HMI 10 is a device that receives an operation from an occupant of a subject vehicle and outputs information. The HMI 10 includes a touch panel 11, a primary switch 12, an operation start switch 13, an operation cancel switch 14, and the like, for example. The touch panel 11 may have a configuration in which a touch pad is combined with a display device such as a liquid crystal display (LCD), or an organic electro luminescence (EL) display, for example. The primary switch 12 is an example of a “first switch,” the operation start switch 13 is an example of a “second switch,” and the operation cancel switch 14 is an example of a “third switch”.

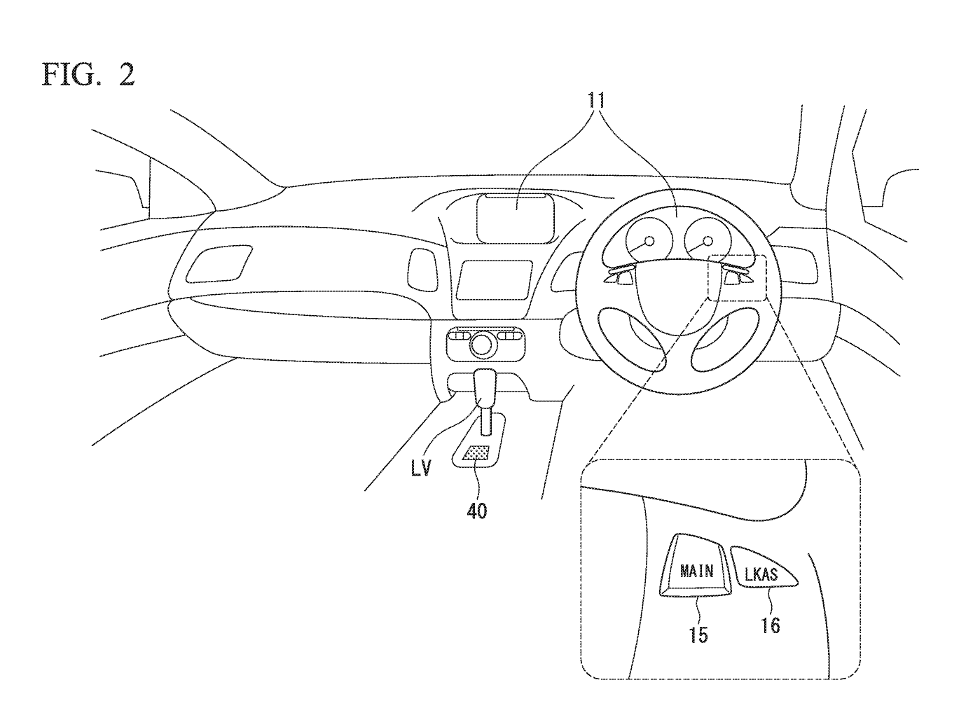

FIG. 2 is a diagram illustrating an example of an installation position of the touch panel 11. As illustrated in the drawing, the touch panel 11 is positioned under a front windshield and is installed on the dashboard provided in front of a driver's seat and a passenger's seat, for example. The touch panel 11 may be installed in front of the driver's seat and may function as an instrument panel (a fascia) that displays instruments such as a speedometer or a tachometer. A main switch 15 and a lane-keeping assistance system (LKAS) operation switch 16 to be described below are provided on a steering wheel provided in front of the driver's seat. The main switch 15 and the LKAS operation switch 16 may be included in the HMI 10. A shift lever (a selector) LV and the brake switch 40 are provided on a console between the driver's seat and the passenger's seat. The brake switch 40 is an example of a “fourth switch”. Moreover, the instruments such as a speedometer or a tachometer are examples of “information on a vehicle”.

The primary switch 12 is a switch for putting the operation start switch 13 into an operable state. The “operable state” is a state in which an operation on a switch is enabled, for example, and more specifically, is a state in which the driving assistance device 100 starts a specific process on the basis of a signal generated when a switch is operated. On the other hand, a “non-operable state” is a state in which an operation on a switch is disabled, for example, and more specifically, is a state in which the driving assistance device 100 does not start a specific process on the basis of a signal generated when a switch is operated or a state in which a signal is not generated even when a switch is operated.

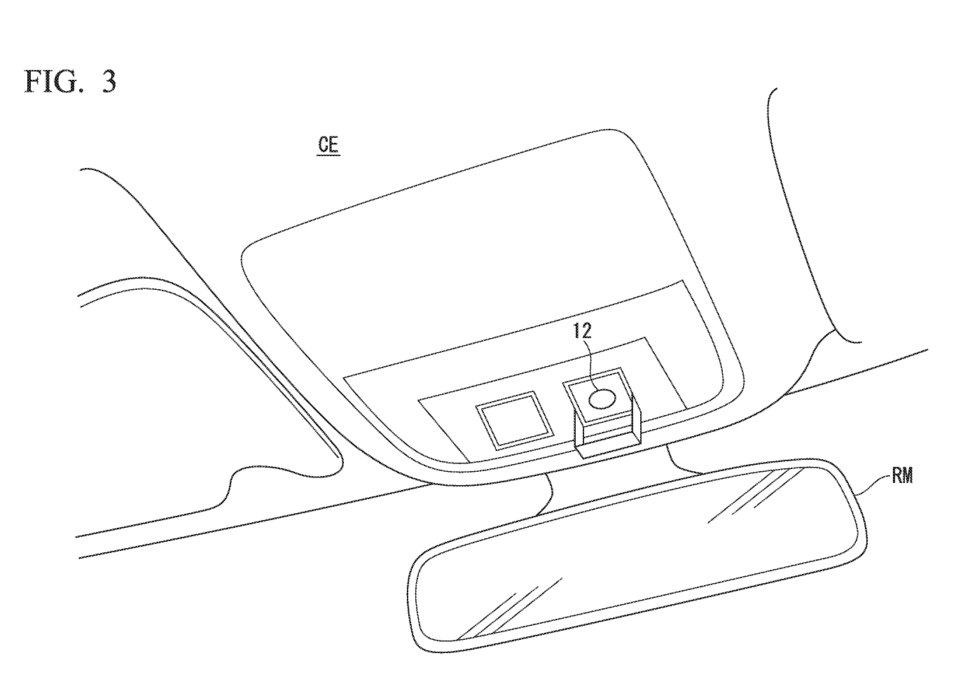

FIG. 3 is a diagram illustrating an example of an installation position of the primary switch 12. As illustrated in the drawing, for example, the primary switch 12 is installed on a vehicle front side (for example, near a rear-view mirror RM) of an interior roof CE.

The operation start switch 13 is a switch for causing the autonomous emergency stop controller 110 to start autonomous emergency stop control to be described below. The operation cancel switch 14 is a switch for causing the autonomous emergency stop controller 110 to stop the autonomous emergency stop control. These aspects will be described below.

The radar apparatus 20 radiates radio waves such as millimeter waves in front of the subject vehicle and detects radio waves (reflection waves) reflected from an object to detect at least the position (the distance and the azimuth) of the object. One or a plurality of the radar apparatuses 20 are attached to arbitrary positions of the subject vehicle M. The radar apparatus 20 may detect the position and the speed of an object according to a frequency modulated continuous wave (FM-CW) method. The radar apparatus 20 outputs the detection result to the driving assistance device 100.

The camera 22 is a digital camera which uses a solid-state image-capturing device such as a charge coupled device (CCD) or a complementary metal oxide semiconductor (CMOS), for example. One or a plurality of the cameras 22 are attached to arbitrary positions of the subject vehicle. When capturing the image of the front side, the camera 22 is attached to the upper part of the front windshield or the back surface of the rear-view mirror. The camera 22 captures the images around the subject vehicle repeatedly and periodically, for example. The camera 22 may be a stereo camera. The camera 22 outputs the captured images to the image recognition device 24.

The image recognition device 24 performs image processing on the images captured by the camera 22 to recognize the position, the kind, the speed, and the like of each of the objects present around the subject vehicle. The image recognition device 24 outputs the recognition result to the driving assistance device 100.

The vehicle speed sensor 30 detects the speed of the subject vehicle. The vehicle speed sensor 30 outputs the detection result to the driving assistance device 100.

The brake switch 40 is a switch for causing the electronic parking brake controller 170 to start processing.

The brake pressure sensor 42 is attached to a brake pedal to detect the amount of depression (pressure) of the brake pedal. The brake pressure sensor 42 outputs the detection result to the driving assistance device 100. The accelerator-opening sensor 44 is attached to an accelerator pedal to detect the amount of operation of the accelerator pedal. The accelerator-opening sensor 44 outputs the detection result to the driving assistance device 100. The steering angle sensor 46 detects an operation angle of the steering wheel or the torque (hereinafter referred to as steering torque) applied to the shaft of the steering wheel. The steering angle sensor 46 outputs the detection result to the driving assistance device 100.

The throttle actuator 60 outputs a drive force of the subject vehicle by driving the driving mechanism 61. The driving mechanism 61 includes an engine, a spark plug for igniting fuel supplied to the engine, a fuel injector for adjusting the fuel injected to the engine, a throttle valve for supplying outside air to the engine, and the like, for example. For example, the throttle actuator 60 causes the spark plug to spark and supplies electric power to a solenoid provided in the fuel injector to drive a plunger that passes through the solenoid. Moreover, the throttle actuator 60 regulates an opening (a throttle opening) of the valve by driving the throttle valve.

The brake actuator 62 adjusts a braking force acting on the subject vehicle by driving the braking mechanism 63. The braking mechanism 63 includes a brake caliper of a brake pad, a cylinder for delivering hydraulic pressure to the brake caliper, a pump for adjusting the flow rate of brake fluid (oil) in the cylinder, and the like, for example. The braking mechanism 63 may separately include a mechanism (a drum brake mechanism) for driving a brake shoe with the aid of a booster and a mechanism (a disc brake mechanism) for directly driving a brake shoe with the aid of a brake pad as described above.

The steering actuator 64 outputs a steering force to the wheels by driving the steering mechanism 65. The steering mechanism 65 includes a hydraulic or electric power steering mechanism, for example. Moreover, the steering actuator 64 may output a reaction force to the steering wheel by driving the steering mechanism 65. The “reaction force” is torque in the opposite direction from the steering torque applied to the shaft of the steering wheel by the operation of an occupant, for example.

The hazard lamp 70 is attached mostly to the back part of the subject vehicle to perform a blinking operation in a turned-on state. The audio input/output device 80 includes a speaker. The audio input/output device 80 may be a separate configuration from the HMI 10 and may be a partial configuration of the HMI 10.

The communication device 90 communicates with various server devices via a radio base station using a cellular network, a Wi-Fi network, or the like, for example. Moreover, the communication device 90 may call a predetermined telephone number using a cellular network.

### [Autonomous Emergency Stop Control]

Hereinafter, the autonomous emergency stop controller 110 will be described. The autonomous emergency stop controller 110 performs control (hereinafter, autonomous emergency stop control) to gradually decelerate and stop the subject vehicle according to an operation of an occupant of the subject vehicle. For example, when it is determined that a physical condition is worsening and it is difficult to continue driving, the occupant of the subject vehicle operates the primary switch 12 and the operation start switch 13 to cause the autonomous emergency stop controller 110 to start the autonomous emergency stop control.

The autonomous emergency stop controller 110 may automatically stop the subject vehicle in a predetermined area while gradually decelerating the subject vehicle as the autonomous emergency stop control. The predetermined area is a place (more specifically, the shoulder of a road) where the subject vehicle does not or not easily interfere with the travel of other vehicles (hereinafter surrounding vehicles) present around the subject vehicle, for example. When moving the subject vehicle to the shoulder of a road and is stopped, the autonomous emergency stop controller 110 may instruct the lane-keeping assistance controller 130 to stop its operation and may perform steering control of moving the subject vehicle to a predetermined area as the autonomous emergency stop control.

The autonomous emergency stop control may be automatically started when an occupant sitting on the driver's seat is in a state in which it is difficult to continue driving. In line with the autonomous emergency stop control, a phone call may be made to an emergency center or the like or information may be sent via an email or the like.

The autonomous emergency stop controller 110 includes, for example, an output control component 112, a forward obstacle recognition component 114, a lane recognition component 116, a throttle closing control component 118, a braking amount-determining component 120, a steering assist amount-determining component 122, a hazard lamp blinking instruction component 124, a vehicle stop-determining component 126, and an operation instruction component 128.

The output control component 112 controls the HMI 10, the audio input/output device 80, and the communication device 90. For example, when the primary switch 12 is operated, the output control component 112 controls the communication device 90 to call a predetermined phone number (for example, the phone number of an emergency center). Hereinafter, this processing operation will be referred to as “emergency notification”. The output control component 112 may perform emergency notification by controlling the communication device 90 to transmit predetermined information (for example, an email) to an external server device.

When the primary switch 12 is operated, the output control component 112 causes the touch panel 11 to display the operation start switch 13 and the operation cancel switch 14 in a non-operable state (a state in which an operation on the switches is disabled).

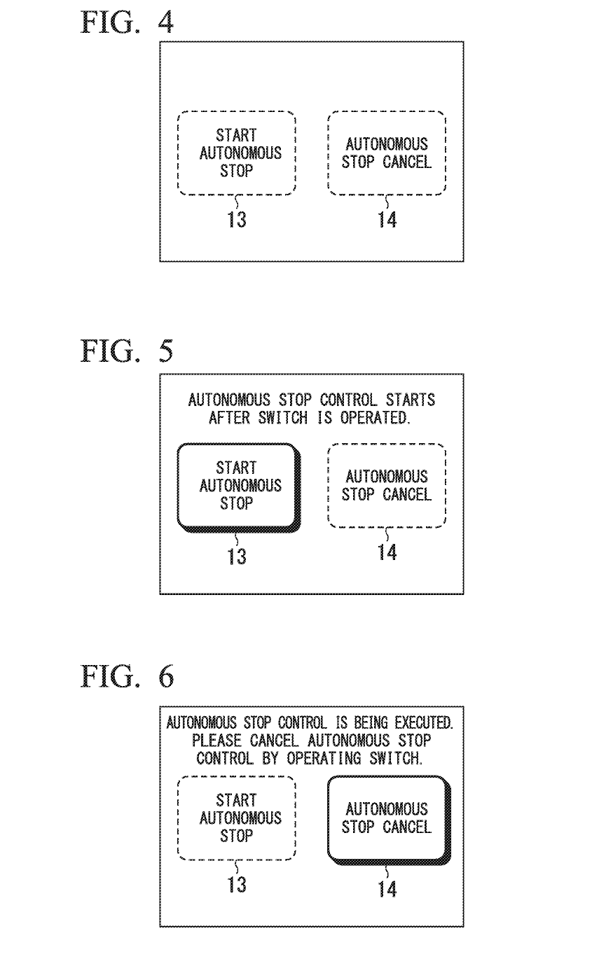

FIG. 4 is a diagram illustrating an example of a screen displayed on the touch panel 11 when the primary switch 12 is operated. For example, the output control component 112 causes the touch panel 11 to gray out the operation start switch 13 and the operation cancel switch 14 to notify the occupant of the fact that these switches are in a non-operable state (an operation on the switches is disabled). The output control component 112 causes the touch panel 11 to continuously display such a screen until a predetermined period (for example, approximately three seconds) has elapsed after the primary switch 12 is operated.

When the predetermined period has elapsed after the primary switch 12 is operated, the output control component 112 causes the touch panel 11 to display the operation start switch 13 in an operable state and display the operation cancel switch 14 in a non-operable state.

FIG. 5 is a diagram illustrating an example of a screen displayed on the touch panel 11 after a predetermined period has elapsed. For example, the outer circumferential surface 112 notifies the occupant of the fact that the operation start switch 13 has newly entered into an operable state (an operation of the switch is enabled) by causing the touch panel 11 to highlight the operation start switch 13 and gray out the operation cancel switch 14. In this case, the output control component 112 notifies the occupant via characters or audio of the fact that the autonomous emergency stop control has started when the highlighted operation start switch 13 is operated (touched).

When the operation start switch 13 displayed in an operable state is operated by the occupant, the output control component 112 causes the touch panel 11 to display the operation start switch 13 in a non-operable state and display the operation cancel switch 14 in an operable state.

FIG. 6 is a diagram illustrating an example of a screen displayed on the touch panel 11 when the operation start switch 13 is operated. For example, the output control component 112 notifies the occupant of the fact that the operation cancel switch 14 has newly entered into an operable state by causing the touch panel 11 to gray out the operation start switch 13 and highlight the operation cancel switch 14. In this case, the output control component 112 notifies the occupant via characters or audio of the fact that the autonomous emergency stop control is disabled (ended) when the highlighted operation cancel switch 14 is operated (touched).

Although the operation start switch 13 and the operation cancel switch 14 in the above-described example are described as being imaginary switches displayed on the touch panel 11, the present invention is not limited thereto. For example, the operation start switch 13 and the operation cancel switch 14 may be provided separately as mechanical switches. In this case, the touch panel 11 may be a display device such as a LCD, for example.

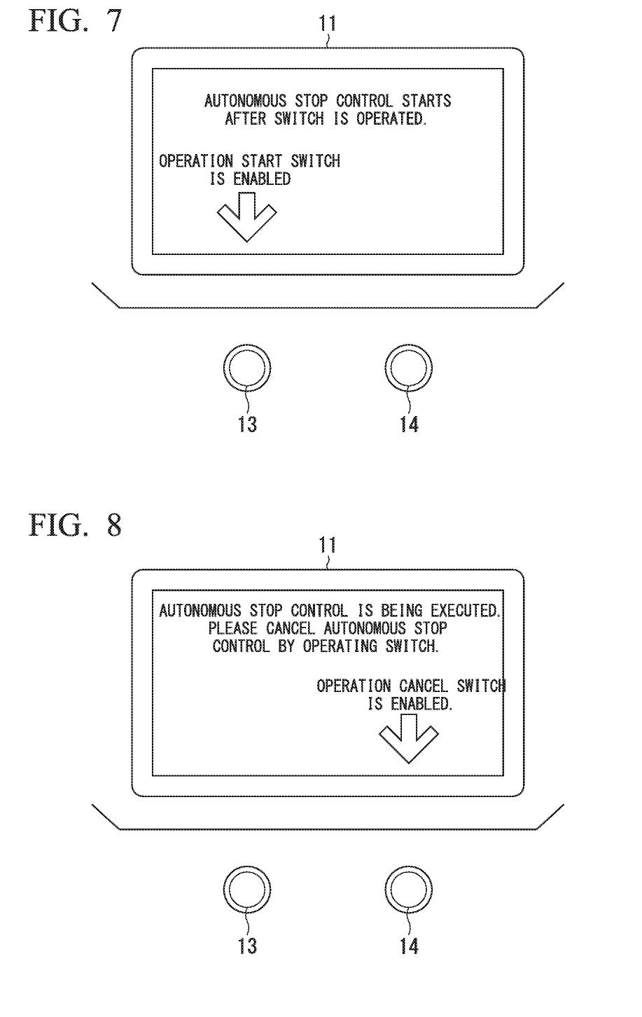

FIG. 7 is a diagram illustrating an example of a screen displayed on the touch panel 11 when the operation start switch 13 and the operation cancel switch 14 are mechanical switches. As in the illustrated example, the operation start switch 13 and the operation cancel switch 14 are provided on the lower side of the touch panel 11. For example, when a predetermined period has elapsed after the primary switch 12 is operated, the output control component 112 causes the operation start switch 13 to transition from a non-operable state to an operable state and causes the operation cancel switch 14 to be maintained in a non-operable state. The output control component 112 causes the touch panel 11 to display characters or symbols indicating that the operation start switch 13 has entered into an operable state. In the illustrated example, the output control component 112 displays characters “operation start switch is enabled” and an arrow for indicating that the switch is positioned on the lower side in an area of the screen positioned above the upper side of the operation start switch 13.

FIG. 8 is a diagram illustrating another example of a screen displayed on the touch panel 11 when the operation start switch 13 and the operation cancel switch 14 are mechanical switches. For example, when the operation start switch 13 having transitioned to an operable state is operated by the occupant, the output control component 112 causes the operation start switch 13 to transition from the operable state to the non-operable state and causes the operation cancel switch 14 to transition from the non-operable state to the operable state. The output control component 112 causes the touch panel 11 to display characters or symbols indicating that the operation cancel switch 14 has entered into an operable state. In the illustrated example, the output control component 112 displays characters “operation cancel switch is enabled” and an arrow for indicating that the switch is positioned on the lower side in an area of the screen positioned above the upper side of the operation cancel switch 14.

The forward obstacle recognition component 114 recognizes the position and the speed of an obstacle present in front of the subject vehicle by referring to the detection result of the radar apparatus 20 and the recognition result of the image recognition device 24 in order to determine a target position at which the subject vehicle is to be automatically stopped. The obstacle is a vehicle, a pedestrian, a bicycle, and other objects, for example.

The lane recognition component 116 recognizes the position of a lane mark LM and the position of a lane of a road present around the subject vehicle by referring to the recognition result of the image recognition device 24. For example, the lane recognition component 116 recognizes lane marks LM of a road from the image captured by the camera 22 and recognizes a lane defined by two lane marks LM closest to the subject vehicle among the recognized lane marks LM as a traveling lane. Moreover, a subject vehicle position recognition component 204 recognizes a relative position and an attitude of the subject vehicle in relation to the recognized traveling lane.

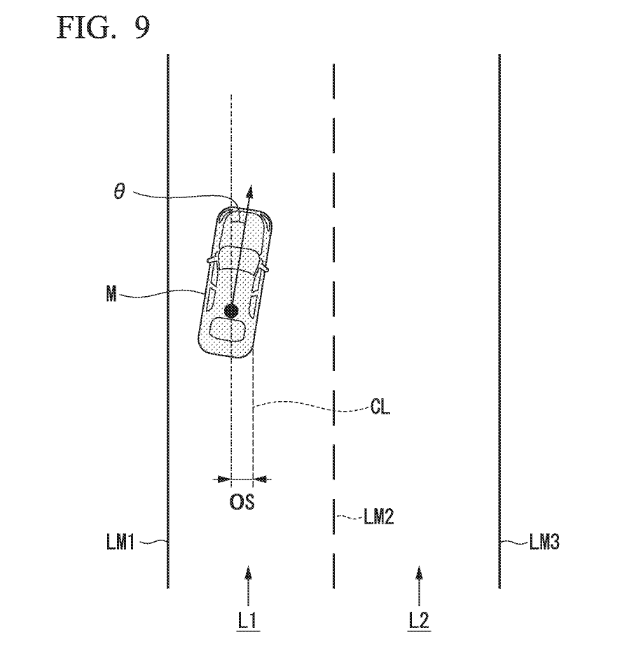

FIG. 9 is a diagram illustrating how the relative position and the attitude of the subject vehicle M in relation to the traveling lane L1 are recognized by the lane recognition component 116. For example, the lane recognition component 116 recognizes lane marks LM1 to LM3 and recognizes a region between the lane marks LM1 and LM2 closest to the subject vehicle as the traveling lane L1 of the subject vehicle. The lane recognition component 116 recognizes the distance OS of a reference point (for example, the center of gravity) of the subject vehicle from the lane center CL of the traveling lane L1 as the relative position of the subject vehicle in relation to the traveling lane L1. Moreover, the lane recognition component 116 recognizes an angle θ between the lane center CL and the traveling direction of the subject vehicle as the attitude of the subject vehicle in relation to the traveling lane L1. Instead of this, the lane recognition component 116 may recognize the position or the like of the reference point of the subject vehicle in relation to any one of the side ends of the subject lane L1 as the relative position of the subject vehicle in relation to the recognized traveling lane.

The throttle closing control component 118 controls the throttle actuator 60 to put the throttle opening into a fully closed state as the autonomous emergency stop control.

The braking amount-determining component 120 determines a braking amount (braking force) for stopping the subject vehicle and controls the brake actuator 62 according to the determined braking amount as the autonomous emergency stop control. For example, the braking amount-determining component 120 determines the braking amount on the basis of the position of an obstacle in the front and back of the subject vehicle and the speed of the subject vehicle so that the subject vehicle decelerates at a constant deceleration to reach a stopping state. The “stopping state” may be a stopping state in which the speed of the subject vehicle is zero and may be a state in which the speed of the subject vehicle is smaller than a stop determination threshold Vstp (for example, several [km/h]). A specific method for determining the braking amount is not particularly limited and an arbitrary method such as speed feedback may be used. When the braking amount determined by the braking amount-determining component 120 is smaller than the braking amount based on the detection result of the brake pressure sensor 42, the braking amount-determining component 120 may control the brake actuator 62 according to the latter braking amount.

The steering assist amount-determining component 122 determines a steering assist amount for guiding the subject vehicle to the target position and controls the steering actuator 64 according to the determined steering assist amount as the autonomous emergency stop control. The “steering assist amount” is a torque amount of the steering torque applied to the steering wheel, for example. More specifically, the “steering assist amount” includes a torque amount of a steering torque in the same direction as the steering torque by an occupant's operation and a torque amount of a steering torque (negative steering torque=reaction force) in the opposite direction from the steering torque by the occupant's operation.

The hazard lamp blinking instruction component 124 continuously operates the hazard lamp 70 as the autonomous emergency stop control (instructs the hazard lamp 70 to blink or be turned on).

The vehicle stop-determining component 126 determines whether the subject vehicle is stopped in the course of the autonomous emergency stop control. Specifically, the vehicle stop-determining component 126 determines whether the speed of the subject vehicle output by the vehicle speed sensor 30 is smaller than the stop determination threshold Vstp and determines that the subject vehicle is stopped when the speed of the subject vehicle is smaller than the stop determination threshold Vstp. The stop determination threshold Vstp is an example of a “predetermined speed”.

The operation instruction component 128 instructs some or all of the lane-keeping assistance controller 130, the adaptive cruise assistance controller 150, and the electronic parking brake controller 170 to operate or stop operating on the basis of the presence of an operation on the primary switch 12 or the operation start switch 13 and the determination result of the vehicle stop-determining component 126.

For example, the operation instruction component 128 instructs the lane-keeping assistance controller 130 to operate when the operation start switch 13 is operated and the lane-keeping assistance controller 130 is not operating. Moreover, the operation instruction component 128 may instruct the lane-keeping assistance controller 130 to operate when the primary switch 12 is operated and the lane-keeping assistance controller 130 is not operating.

The operation instruction component 128 instructs the adaptive cruise assistance controller 150 to stop operating when the operation start switch 12 is operated and the adaptive cruise assistance controller 150 is operating. Moreover, the operation instruction component 128 may instruct the adaptive cruise assistance controller 150 to stop operating when the primary switch 12 is operated and the adaptive cruise assistance controller 150 is operating.

The operation instruction component 128 instructs the electronic parking brake controller 170 to operate when the vehicle stop-determining component 126 determines that the subject vehicle is stopped.

The autonomous emergency stop controller 110 does not stop operating due to override similarly to the electronic parking brake controller 170 to be described below (the control in execution is continued without being cancelled). Override refers to a state in which the control by the driving assistance device 100 is disabled and the driving operation of the occupant is enabled when a driving operator such as an accelerator pedal, a brake pedal, or a steering wheel is operated by the occupant with a certain force (operation amount) or more. That is, override refers to a state in which the power to control the subject vehicle is handed over from the vehicle to the occupant.

### [Land Keeping Assistance Control]

The lane-keeping assistance controller 130 includes a lane recognition component 132 and a steering assistance control component 134, for example. The lane recognition component 132 starts processing for recognizing the relative position and the attitude of the subject vehicle in relation to the traveling lane when the main switch 15 is operated. For example, similarly to the lane recognition component 116 of the autonomous emergency stop controller 110, the lane recognition component 132 recognizes a region defined by two lane marks LM closest to the subject vehicle among the lane marks LM of the road as a traveling lane and recognizes the relative position and the attitude of the subject vehicle in relation to the traveling lane.

The steering assistance control component 134 controls the steering actuator 64 so as to maintain the subject lane recognized by the lane recognition component 132 when the LKAS operation switch 16 is operated. Hereinafter, such control will be referred to as “lane-keeping assistance control (=LKAS)).

The LKAS operation switch 15 enters into a state (a non-operable state) in which an operation is not received until a predetermined period has elapsed after the main switch 15 is operated and enters into a state (an operable state) in which an operation is received after the predetermined period has elapsed. The predetermined period is set in advance to a period longer than a period taken until a traveling lane or the position and the attitude of the subject vehicle in relation to the lane are recognized after the lane recognition component 132 starts processing, for example.

For example, when the LKAS operation switch 16 having entered into an operation receiving state receives an operation from the occupant, the steering assistance control component 134 applies a reaction force to the shaft of the steering wheel so that the subject vehicle passes over the lane center CL of the subject lane as the lane-keeping assistance control. In this case, the reaction force is steering torque in the same direction as the steering torque applied to the shaft when the steering wheel is turned toward the lane center.

The steering assistance control component 134 performs lane departure suppression control when the subject vehicle travels along positions shifted toward the left or right side from the lane center CL of the subject lane after the main switch 15 or the LKAS operation switch 16 is operated. For example, the steering assistance control component 134 performs the following control as the lane departure suppression control.

For example, the steering assistance control component 134 draws the occupant's attention by vibrating the steering wheel when the subject vehicle approaches the lane mark LM such that the distance between the subject vehicle and the lane mark LM that defines the subject lane reaches a predetermined distance or smaller. In this case, the steering assistance control component 134 notifies the occupant of the fact that the subject vehicle is likely to depart from the subject lane by displaying an image on the touch panel 11 and outputting voice or the like from the speaker. When no operation is input from the occupant to the steering wheel (when a steering angle or steering torque is smaller than a threshold) after the steering wheel is vibrated, the steering assistance control component 134 applies a reaction force to the shaft of the steering wheel by controlling the steering actuator 64. In this case, the reaction force is steering torque in the same direction as the steering torque applied to the shaft when the steering wheel is turned toward the lane center similarly to the lane-keeping assistance control.

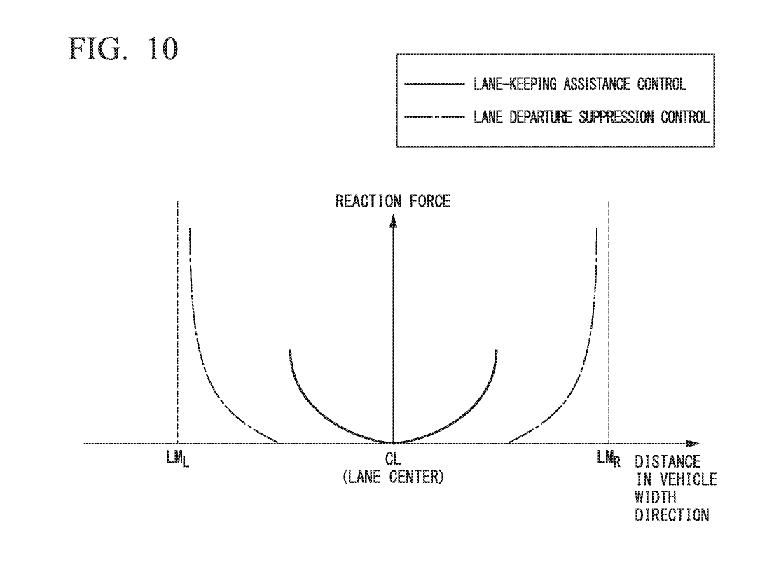

FIG. 10 is a diagram illustrating an example of the relationship between a reaction force and the relative position of the subject vehicle in relation to the subject lane. The vertical axis in the drawing indicates the absolute value of a reaction force (steering torque) applied to the shaft of the steering wheel and the horizontal axis indicates the distance in the vehicle width direction of the lane. Moreover, LM_{R} indicates the lane mark on the right side of the traveling direction and LM_{L} indicates the lane mark on the left side of the traveling direction. As illustrated in the drawing, the steering assistance control component 134 performs lane-keeping assistance control such that the farther the subject vehicle moves from the lane center CL, the larger the reaction force becomes. Moreover, the steering assistance control component 134 performs lane departure suppression control such that the closer the subject vehicle moves toward the lane mark LM (LM_{R} or LM_{L}), the larger the reaction force becomes. The maximum value of the reaction force output during the lane departure suppression control may be larger than the maximum value of the reaction force output during the lane-keeping assistance control. Moreover, the degree of increase (the amount of change in the reaction force according to distance) in the reaction force during the lane departure suppression control may be larger than that during the lane-keeping assistance control.

### [Adaptive Cruise Assistance Control]

The adaptive cruise assistance controller 150 includes a vehicle recognition component 152 and a speed assistance control component 154, for example. The vehicle recognition component 152 recognizes the position and the speed of a vehicle present around the subject vehicle on the basis of the detection result of the radar apparatus 20 and the recognition result of the image recognition device 24.

The speed assistance control component 154 controls the throttle actuator 60 and the brake actuator 62 to accelerate or decelerate the subject vehicle within a predetermined set vehicle speed (for example, 50 to 100 [km/h]) so that the subject vehicle follows a surrounding vehicle (hereinafter referred to as a preceding vehicle) present within a predetermined distance (for example, approximately 50 [m]) in front of the subject vehicle among the surrounding vehicles recognized by the vehicle recognition component 152. Here, “follows” is a travel aspect in which the relative distance (a vehicle-to-vehicle distance) between the subject vehicle and the preceding vehicle is maintained to be constant, for example. Hereinafter, such control will be referred to as “adaptive cruise assistance control”. The speed assistance control component 154 may allow the subject vehicle to travel within the range of the set vehicle speed when a preceding vehicle is not recognized by the vehicle recognition component 152.

### [Electronic Parking Brake Control]

The electronic parking brake controller 170 includes a brake-holding control component 172 and an override determination component 174, for example. The brake-holding control component 172 performs control (hereinafter referred to as electronic parking brake control) of holding a stopping state of the subject vehicle when the brake switch 40 is operated or an operation is instructed from the operation instruction component 128 of the autonomous emergency stop controller 110. For example, the brake-holding control component 172 instructs the brake actuator 62 to output a predetermined braking amount to maintain the stopping state of the subject vehicle. The predetermined braking amount is a braking amount with which the subject vehicle can maintain the stopping state even when a road surface on which the subject vehicle is present has a certain gradient.

The override determination component 174 determines whether an operation of instructing override is input to the driving operator. For example, when an operation amount of the brake pedal detected by the brake pressure sensor 42 is larger than a predetermined operation amount, the override determination component 174 determines that the operation on the brake pedal is an operation of instructing override. Moreover, when an operation amount of the accelerator pedal detected by the accelerator-opening sensor 44 is larger than a predetermined operation amount, the override determination component 174 determines that the operation on the accelerator pedal is an operation of instructing override. Moreover, when an operation amount of the steering wheel detected by the steering angle sensor 46 is larger than a predetermined operation amount, the override determination component 174 determines that the operation on the steering wheel is an operation of instructing override.

When it is determined that the operation on the driving operator is an operation of instructing override, and the brake-holding control component 172 performs electronic parking brake control in response to an operation on the brake switch 40, the override determination component 174 causes the brake-holding control component 172 to stop the electronic parking brake control which is currently executed. In this way, for example, when the subject vehicle is stopped by the electronic parking brake control and the occupant steps on the accelerator pedal with a certain force or more, the electronic parking brake control is cancelled and the subject vehicle starts accelerating according to an operation on the accelerator pedal.

On the other hand, when it is determined that an operation on the driving operator is an operation of instructing override, and the brake-holding control component 172 performs electronic parking brake control according to an instruction from the operation instruction component 128, the override determination component 174 causes the brake-holding control component 172 to continue the electronic parking brake control which is currently executed. In this way, for example, even when the subject vehicle is stopped by the electronic parking brake control, and the occupant steps on the accelerator pedal with a certain force or more, the electronic parking brake control is not cancelled.

### [Control Example by Driving Assistance Device]

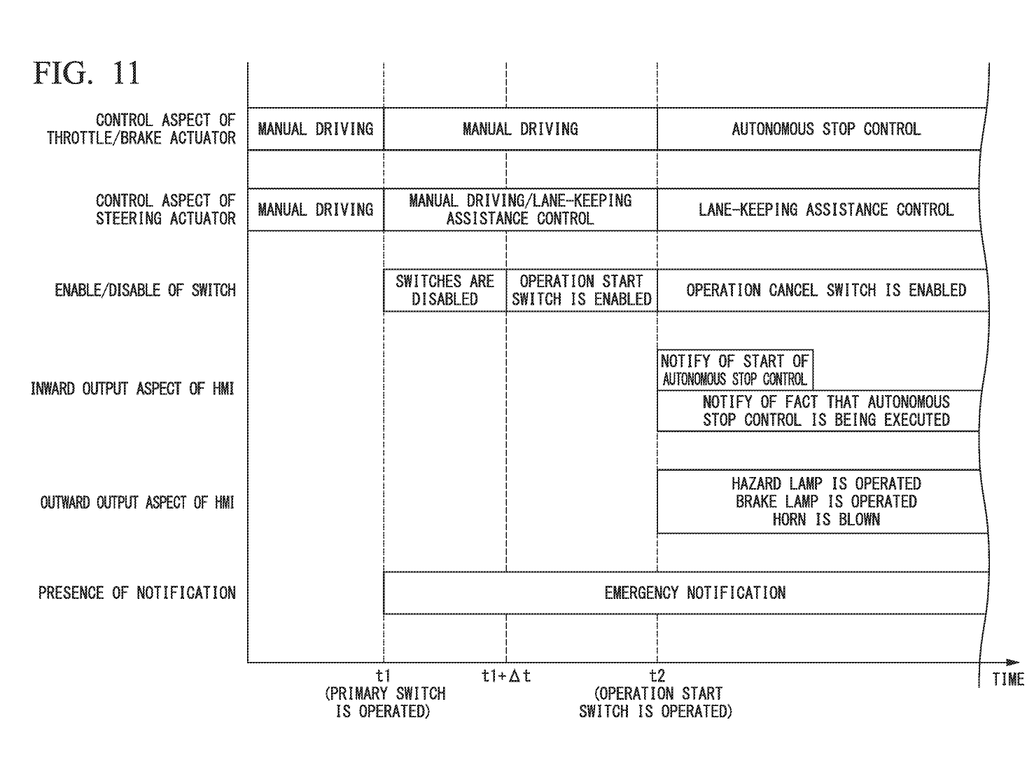

Hereinafter, the timings of respective controls by the driving assistance device 100 will be described. FIG. 11 is a diagram describing the timings of respective controls by the driving assistance device 100. In the drawing, t1 indicates a time point at which the primary switch 12 is operated and t2 indicates a time point at which the operation start switch 13 is operated. Moreover, Δt indicates a standby period (a predetermined period) taken until the operation start switch 13 is enabled after the primary switch 12 is operated.

The illustrated example shows that manual driving is performed until time point t1 without the aid of driving assistance control such as adaptive cruise assistance control, lane-keeping assistance control, or lane departure suppression control. In this case, the operation instruction component 128 does not instruct the adaptive cruise assistance controller 150 to perform an operation at time point t1. Moreover, the operation instruction component 128 may or may not instruct the lane-keeping assistance controller 130 to perform an operation at time point t1.

At time point t1, the output control component 112 causes the touch panel 11 to display the operation start switch 13 and the operation cancel switch 14 in a non-operable state (a state in which an operation on the switch is disabled) and controls the communication device 90 to start emergency notification.

When a predetermined period Δt is elapsed from the time point t1, the output control component 112 causes the touch panel 11 to display the operation start switch 13 in an operable state (a state in which an operation is enabled) and display the operation cancel switch 14 in a non-operable state (a state in which an operation is disabled). In this case, the output control component 112 continues emergency notification.

At time point t2 (that is, when the operation start switch 13 having entered into the operable state is operated), the autonomous emergency stop controller 110 starts autonomous emergency stop control. Moreover, at time point t2, when the lane-keeping assistance controller 130 is not performing the lane-keeping assistance control, the operation instruction component 128 instructs the lane-keeping assistance controller 130 to perform an operation.

The lane-keeping assistance controller 130 having been instructed to perform an operation determines the lane center CL of the subject lane as a control target for maintaining the lane and performs lane-keeping assistance control. When steering control is performed as the autonomous emergency stop control, the operation instruction component 128 of the autonomous emergency stop controller 110 instructs the lane-keeping assistance controller 130 to stop operating and performs steering control of moving the subject vehicle to a predetermined area.

At time point t2, the output control component 112 causes the touch panel 11 to display the operation start switch 13 in a non-operable state (a state in which an operation is disabled) and display the operation cancel switch 14 in an operable state (a state in which an operation is enabled).

At time point t2, the output control component 112 causes the touch panel 11 to display characters or an image indicating that autonomous emergency stop control is started and the autonomous emergency stop control is being executed. Moreover, at time point t2, the output control component 112 operates the hazard lamp 70 or a brake lamp and starts blowing a horn. In this way, the surrounding vehicle is informed of the fact that the subject vehicle will stop.

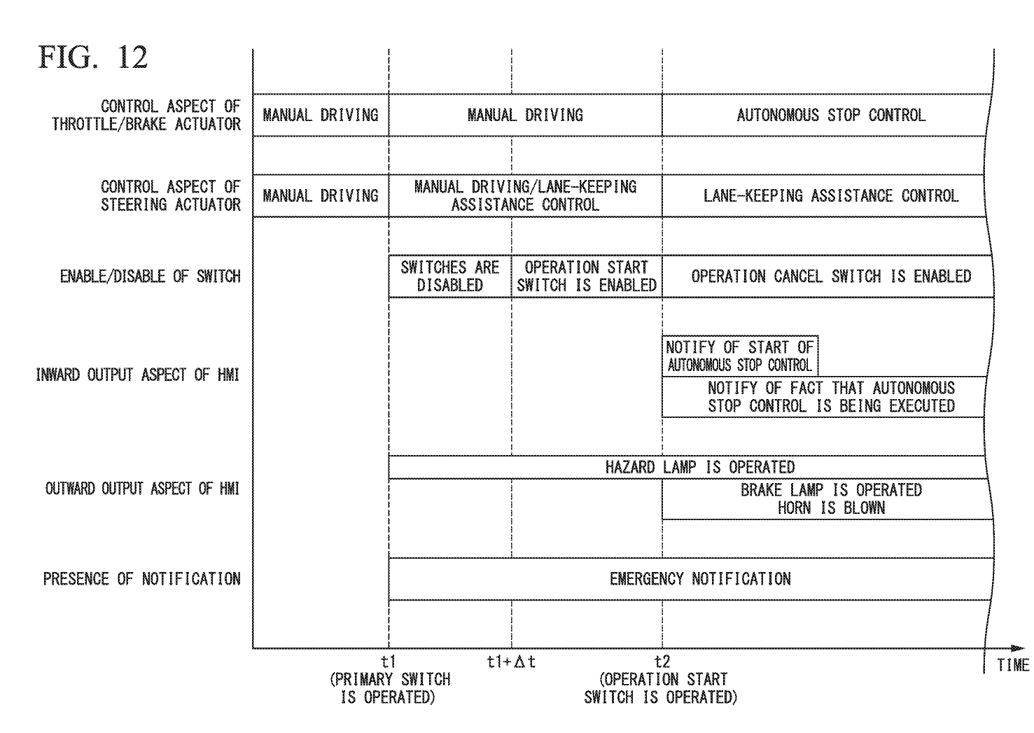

FIG. 12 is a diagram describing the timings of respective controls by the driving assistance device 100. In the example of FIG. 11, although it has been described that the output control component 112 operates the hazard lamp 70 and the like at time point t2 at which the operation start switch 13 is operated, the present invention is not limited thereto. For example, as illustrated in FIG. 12, the output control component 112 may operate the hazard lamp 70 at time point t1 at which the primary switch 12 is operated. In this way, the surrounding vehicle can be informed of the fact that the subject vehicle will stop at an earlier stage.

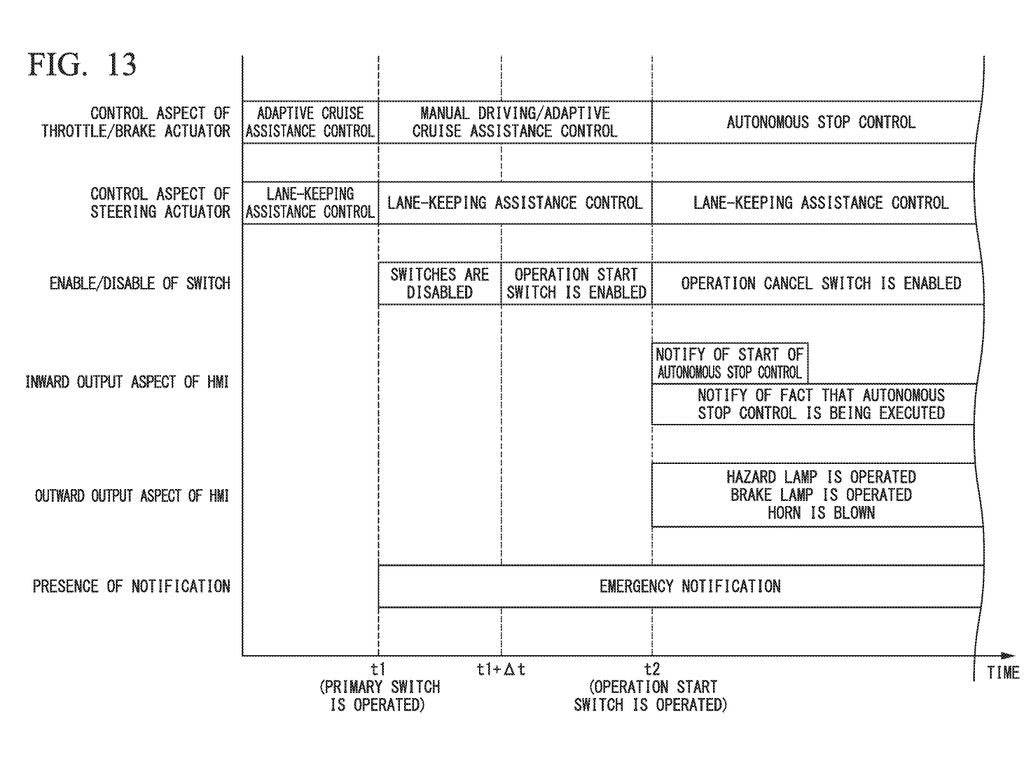

FIG. 13 is a diagram describing the timings of respective controls by the driving assistance device 100. In the examples of FIGS. 11 and 12, although it has been described that when manual driving is performed before time point t1 at which the primary switch 12 is operated, the operation instruction component 128 does not instruct the adaptive cruise assistance controller 150 to perform an operation and instructs the lane-keeping assistance controller 130 to perform an operation or does not instruct the same, the present invention is not limited thereto. For example, as illustrated in FIG. 13, when the adaptive cruise assistance controller 150 and the lane-keeping assistance controller 130 are already operating before time point t1 at which the primary switch 12 is operated, the operation instruction component 128 instructs the adaptive cruise assistance controller 150 to stop its operation or does not instruct the same. Moreover, the operation instruction component 128 does not instruct the lane-keeping assistance controller 130 to stop its operation. In this way, it is possible to transition to the autonomous emergency stop control more smoothly.

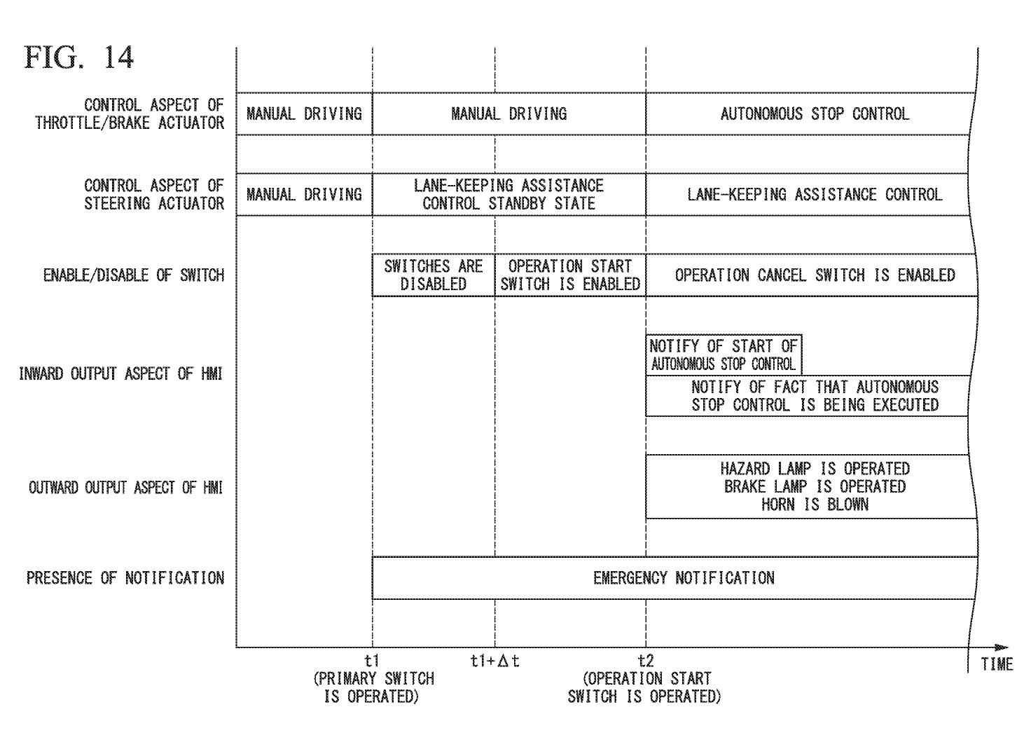

FIG. 14 is a diagram describing the timings of respective controls by the driving assistance device 100. In the example of FIGS. 11 and 12, although it has been described that when manual driving is performed before the time point t1 at which the primary switch 12 is operated, the operation instruction component 128 does not instruct the adaptive cruise assistance controller 150 to perform an operation but instructs the lane-keeping assistance controller 130 to perform an operation or does not instruct the same, the present invention is not limited thereto. For example, as illustrated in FIG. 14, when manual driving is performed earlier than the time point t1 at which the primary switch 12 is operated, the operation instruction component 128 may not instruct the adaptive cruise assistance controller 150 to perform an operation and may instruct the lane-keeping assistance controller 130 have the lane-keeping assistance control on standby.

For example, when the main switch 15 is not operated under the manual driving (that is, the lane recognition component 132 of the lane-keeping assistance controller 130 has not started a recognition process), the manual driving is performed continuously. In such a case, the operation instruction component 128 instructs the lane-keeping assistance controller 130 to have the lane-keeping assistance control on standby. Upon receiving this instruction, the lane recognition component 132 of the lane-keeping assistance controller 130 starts a process for recognizing the relative position and the attitude of the subject vehicle in relation to the traveling lane regardless of an operation on the main switch 15. In this way, it is possible to start the lane-keeping assistance control quickly when the operation start switch 13 is operated.

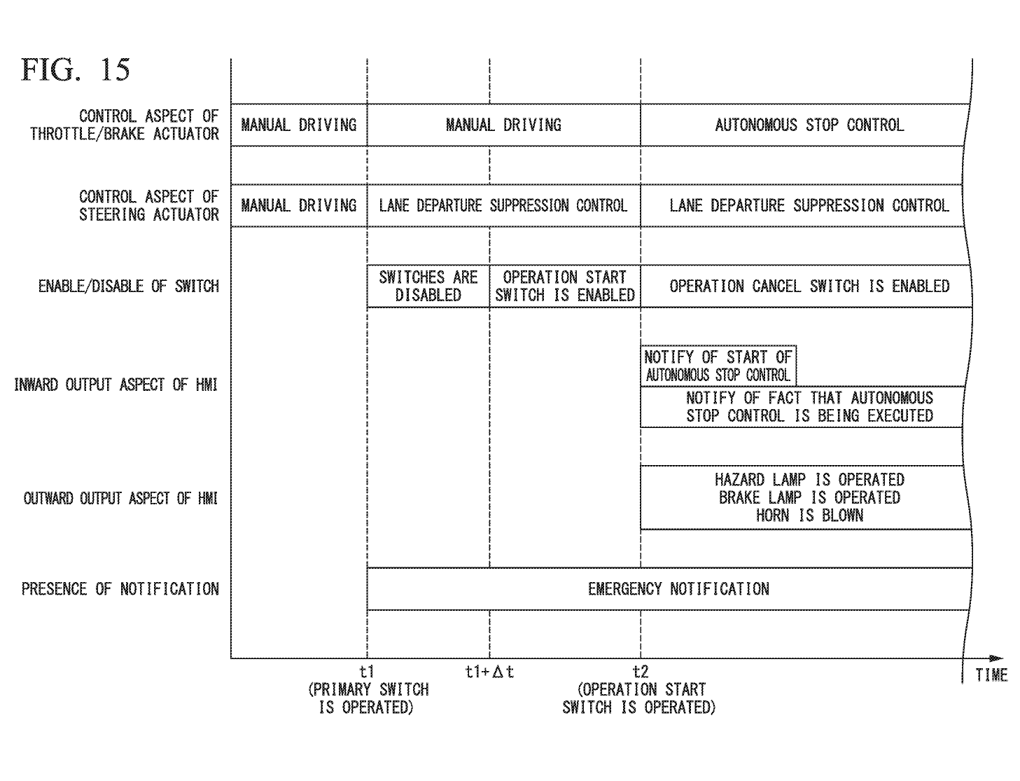

FIG. 15 is a diagram describing the timings of respective controls by the driving assistance device 100. In the example of FIG. 15, when manual driving is performed earlier than the time point t1 at which the primary switch 12 is operated, the operation instruction component 128 may not instruct the adaptive cruise assistance controller 150 to perform an operation and may instruct the lane-keeping assistance controller 130 to perform lane departure suppression control. In this way, the subject vehicle can stop without departing from the traveling lane while the autonomous emergency stop control is being performed.

### [Process Flow]

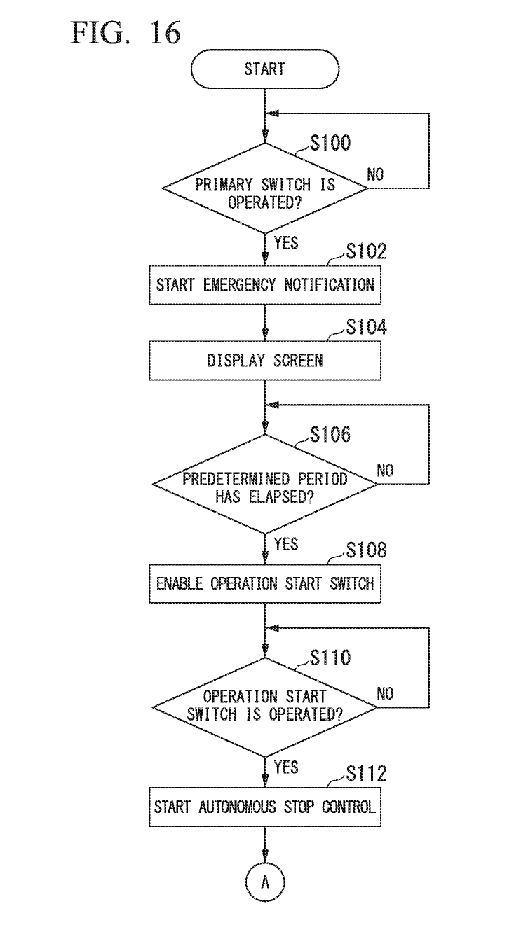

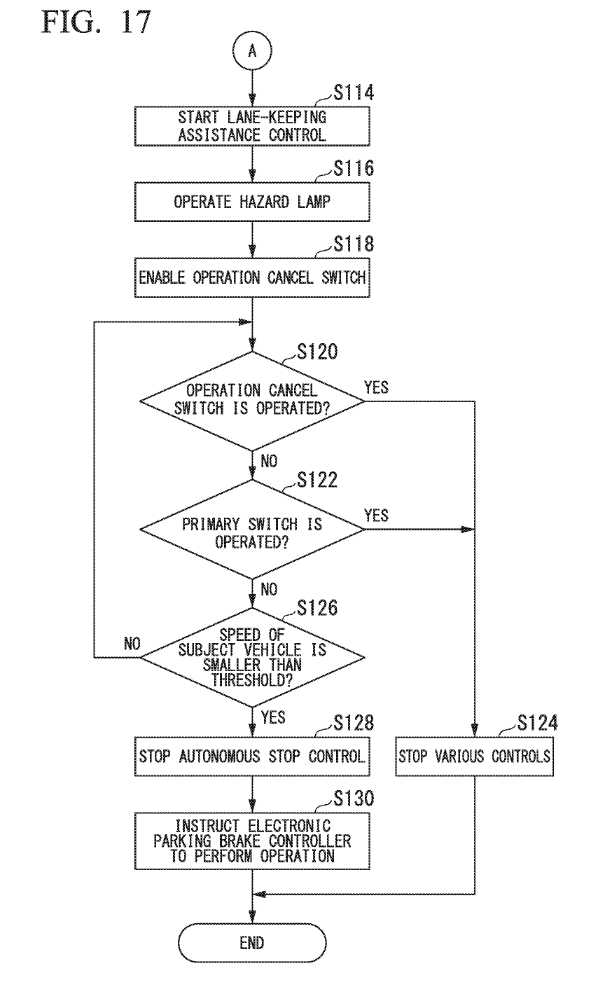

Hereinafter, the flow of a series of processes executed by the driving assistance device 100 according to the first embodiment will be described. FIGS. 16 and 17 are flowcharts illustrating the flow of a series of processes executed by the driving assistance device 100 according to the first embodiment.

First, the output control component 112 waits until the primary switch 12 is operated (step S100). When the primary switch 12 is operated, the output control component 112 controls the communication device 90 to start emergency notification (step S102). Moreover, when the primary switch 12 is operated, the output control component 112 causes the touch panel 11 to display the operation start switch 13 and the operation cancel switch 14 in a non-operable state (a state in which an operation on the switches is disabled (step S104).

Subsequently, the output control component 112 waits until a predetermined period has elapsed after the primary switch 12 is operated (step S106). When the predetermined period has elapsed, the output control component 112 causes the touch panel 11 to display the operation start switch 13 in an operable state (a state in which an operation on the switch is enabled) and display the operation cancel switch 14 in a non-operable state (a state in which an operation on the switch is disabled) (step S108).

Subsequently, the autonomous emergency stop controller 110 determines whether the operation start switch 13 in the operable state is operated (step S110). When it is determined that the operation start switch 13 is operated, the autonomous emergency stop controller 110 starts the autonomous emergency stop control (step S112). The autonomous emergency stop controller 110 does not stop its operation due to override while the autonomous emergency stop control is being performed.

For example, when the operation start switch 13 is operated, the throttle closing control component 118 controls the throttle actuator 60 to put the throttle opening into a fully closed state, the braking amount-determining component 120 determines a braking amount (braking force) for stopping the subject vehicle and controls the brake actuator 62 according to the determined braking amount, and the steering assist amount-determining component 122 determines a steering assist amount for guiding the subject vehicle to the target position and controls the steering actuator 64 according to the determined steering assist amount.

Subsequently, the operation instruction component 128 of the autonomous emergency stop controller 110 instructs the lane-keeping assistance controller 130 to perform an operation. In response to this, the lane-keeping assistance controller 130 starts lane-keeping assistance control (step S114).

Subsequently, the hazard lamp blinking instruction component 124 of the autonomous emergency stop controller 110 operates the hazard lamp 70 (step S116).

Subsequently, the output control component 112 causes the touch panel 11 to display the operation start switch 13 in a non-operable state (a state in which an operation on the switch is disabled) and display the operation cancel switch 14 in an operable state (a state in which an operation on the switch is enabled) (step S118).

Subsequently, the autonomous emergency stop controller 110 determines whether the operation cancel switch 14 in the operable state is operated (step S120). When it is determined that the operation cancel switch 14 is not operated, the autonomous emergency stop controller 110 determines whether the primary switch 12 is operated (step S122).

When it is determined that the operation cancel switch 14 is operated or it is determined that the primary switch 12 is operated, the autonomous emergency stop controller 110 stops various controls that have been started when the operation start switch 13 was operated (step S124).

On the other hand, when it is determined that both the operation cancel switch 14 and the primary switch 12 are not operated, the vehicle stop-determining component 126 determines whether the speed of the subject vehicle is smaller than the stop determination threshold Vstp (step S126).

When it is determined that the speed of the subject vehicle is equal to or larger than the stop determination threshold Vstp, the autonomous emergency stop controller 110 returns to step S120.

On the other hand, when it is determined that the speed of the subject vehicle is smaller than the stop determination threshold Vstp, the autonomous emergency stop controller 110 stops the autonomous emergency stop control (step S128). In this process, the hazard lamp blinking instruction component 124 of the autonomous emergency stop controller 110 may continuously operate the hazard lamp 70.

Subsequently, the operation instruction component 128 instructs the electronic parking brake controller 170 to perform an operation (step S130). In response to this, the brake-holding control component 172 of the electronic parking brake controller 170 starts electronic parking brake control. In this way, the processes of this flowchart end.

In the first embodiment described above, although it has been described that when the primary switch 12 is operated, and subsequently, the operation start switch 13 is operated, the autonomous emergency stop controller 110 starts autonomous emergency stop control, the present invention is not limited thereto. For example, the autonomous emergency stop controller 110 may start the autonomous emergency stop control at the timing at which the primary switch 12 is operated. In this case, a series of processes of S102 to S110 of the flowchart may be omitted, or only the process of S106 may be omitted.

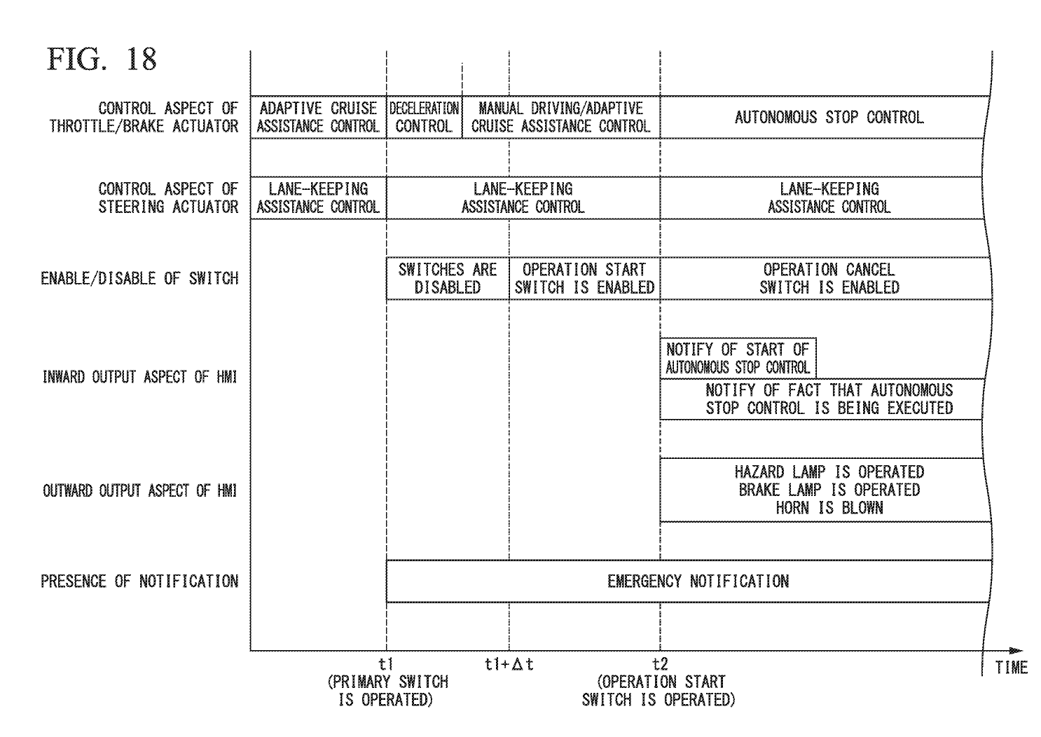

FIG. 18 is a diagram describing the timings of respective controls by the driving assistance device 100. In the example of FIG. 18, similarly to the example of FIG. 13, the adaptive cruise assistance controller 150 and the lane-keeping assistance controller 130 are already operating earlier than the time point t1 at which the primary switch 12 is operated. In such a case, the operation instruction component 128 may instruct the adaptive cruise assistance controller 150 to decelerate the subject vehicle at the time point t1 at which the primary switch 12 is operated. The adaptive cruise assistance controller 150 having received this instruction controls the throttle actuator 60 and the brake actuator 62 to decelerate the subject vehicle, for example. In this case, the adaptive cruise assistance controller 150 applies a braking force (including engine braking force occurring when the throttle opening is put into the fully closed state) smaller than the braking force applied to the subject vehicle during autonomous emergency stop control to the subject vehicle. In this way, it is possible to decelerate the subject vehicle to some extent before the autonomous emergency stop control is started.

In the first embodiment described above, although the starting condition of the autonomous emergency stop control is that the primary switch 12 is operated, and subsequently, the operation start switch 13 is operated, the starting condition of the autonomous emergency stop control may include a condition that the brake switch 40 is operated. For example, when the subject vehicle is not in the stopping state (the speed of the subject vehicle is equal to or larger than the stop determination threshold Vstp) and the brake switch 40 is operated, the operation instruction component 128 of the autonomous emergency stop controller 110 instructs the electronic parking brake controller 170, which is originally scheduled to operate, to stop operating in response to the operation on the brake switch 40. As a result, the electronic parking brake controller 170 does not start the electronic parking brake control but maintains a stopped state. On the other hand, the autonomous emergency stop controller 110 starts the autonomous emergency stop control. Moreover, when the speed of the subject vehicle is equal to or larger than a stop determination threshold Vstp# larger than the stop determination threshold Vstp, the autonomous emergency stop controller 110 may instruct the electronic parking brake controller 170 to stop operating and may start the autonomous emergency stop control on condition that the brake switch 40 is operated. The stop determination threshold Vstp# is a threshold which is clearly distinguished from the threshold for operating the electronic parking brake controller 170 when an operation on the primary switch 12 is used as a starting condition of the autonomous emergency stop control, for example. In this manner, when the stop determination threshold Vstp which is a threshold for operating the electronic parking brake controller 170 is different from the stop determination threshold Vstp# which is a threshold for determining that the speed of the subject vehicle is a certain speed or higher, it is possible to determine whether the occupant is in a state of having difficulty in driving the vehicle in a state in which the speed of the subject vehicle is high to some extent while suppressing the autonomous emergency stop control from operating excessively. The stop determination threshold Vstp# is an example of a “predetermined speed”. Due to such control, even when the occupant cannot extend his or her hands up to the primary switch installed on the interior roof due to reasons such as a worsening physical condition, for example, the occupant can start the autonomous emergency stop control by operating the brake switch 40 on the side surface of the driver's seat.

According to the first embodiment described above, when the operation start switch 13 (a second switch) configured to not receive an operation of an occupant before the primary switch 12 (a first switch) receives an operation of the occupant and receive an operation of the occupant after the primary switch 12 receives an operation of the occupant receives an operation of the occupant (that is, when the operation start switch 13 is operated after the primary switch 12 is operated), the autonomous emergency stop controller 110 can decelerate the vehicle in the event of an emergency after suppressing erroneous operations of the occupant since the subject vehicle is decelerated until the speed of the subject vehicle becomes smaller than the stop determination threshold Vstp.

### Second Embodiment

Hereinafter, a second embodiment will be described. The second embodiment is different from the first embodiment in that the autonomous emergency stop control is started according to the state of the occupant of the subject vehicle instead of or in addition to starting the autonomous emergency stop control in response to an operation on the primary switch 12 and the operation start switch 13. Therefore, such differences will be described mainly and the description of common portions will be omitted.

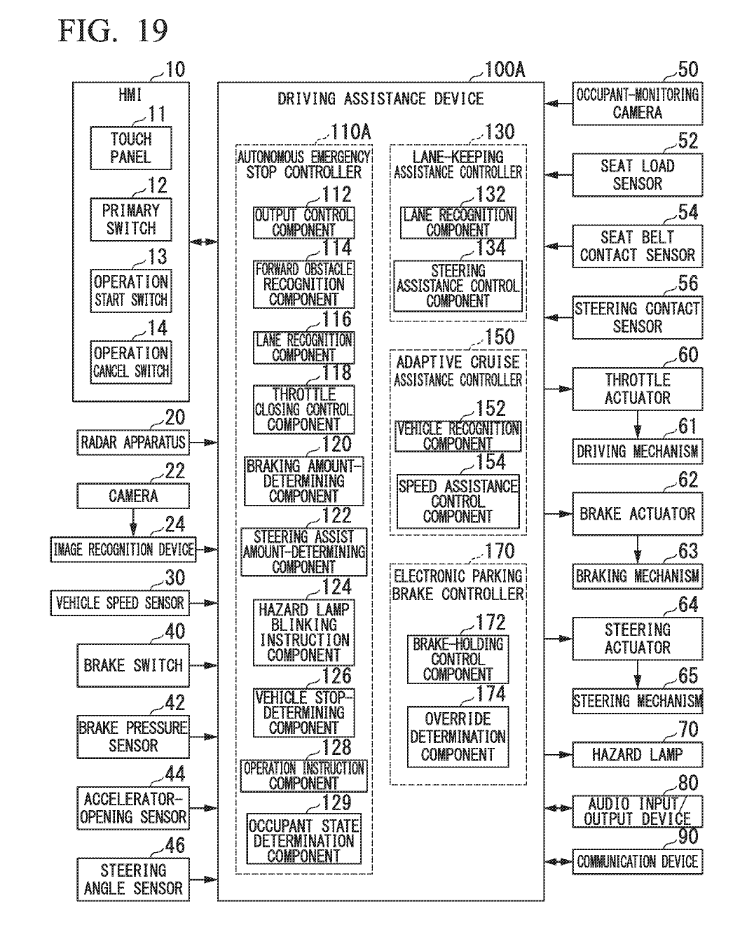

FIG. 19 is a diagram illustrating an example of a configuration of a subject vehicle on which a driving assistance device 100A according to the second embodiment is mounted. The driving assistance device 100A further includes an occupant-monitoring camera 50, a seat load sensor 52, a seat belt contact sensor 54, and a steering contact sensor 56 in addition to the HMI 10, the radar apparatus 20, the camera 22, the image recognition device 24, the vehicle speed sensor 30, the brake switch 40, the brake pressure sensor 42, the accelerator-opening sensor 44, the steering angle sensor 46, the throttle actuator 60, the driving mechanism 61, the brake actuator 62, the braking mechanism 63, the steering actuator 64, the steering mechanism 65, the hazard lamp 70, the audio input/output device 80, and the communication device 90.

The occupant-monitoring camera 50 is a digital camera which uses a solid-state image-capturing device such as a CCD or a CMOS. The occupant-monitoring camera 50 mainly captures the image of the face of an occupant sitting on the driver's seat. The occupant-monitoring camera 50 outputs the captured image to the driving assistance device 100A.

The seat load sensor 52 detects a load applied to the seats such as the driver's seat and the passenger's seat and outputs the detection result to the driving assistance device 100A.

The seat belt contact sensor 54 detects attachment of a seat belt and outputs the detection result to the driving assistance device 100A.

The steering contact sensor 56 is an electrostatic capacitance sensor provided in the steering wheel 82, for example. The steering contact sensor 56 detects the approach or contact of an object (for example, the hand of the occupant) to the steering wheel 82 as a change in electrostatic capacitance and outputs the detection result to the driving assistance device 100A.

An autonomous emergency stop controller 100A of the driving assistance device 100A according to the second embodiment further includes an occupant state determination component 129 in addition to the output control component 112, the forward obstacle recognition component 114, the lane recognition component 116, the throttle closing control component 118, the braking amount-determining component 120, the steering assist amount-determining component 122, the hazard lamp blinking instruction component 124, the vehicle stop-determining component 126, and the operation instruction component 128, for example.

The occupant state determination component 129 analyzes the image captured by the occupant-monitoring camera 50, for example, and determines whether the occupant sitting on the driver's seat is in a state of having difficulty in continuing to drive. For example, the occupant state determination component 129 determines whether the occupant is in a state of having difficulty in continuing to drive on the basis of the movement of the eyes of the occupant, the state of the eyelids, and the like. The state of having difficulty in continuing to drive is an example of a “predetermined state”.

The occupant state determination component 129 may determine whether the occupant sitting on the driver's seat is in the state of having difficulty in continuing to drive on the basis of some or all detection results of the seat load sensor 52, the seat belt contact sensor 54, and the steering contact sensor 56.

For example, an occupant may fall forward (take a forward leaning attitude) while sitting on the driver's seat due to reasons such as a worsening physical condition. In this case, a larger load than that before the occupant falls forward is applied to the seat belt and the seat belt is extended. The seat belt contact sensor 54 detects the length of the belt when the seat belt is extended. Moreover, when the occupant falls forward, the center of gravity of the occupant moves toward the forward side of the subject vehicle. In this case, the distribution of the load applied to the seat changes. The seat load sensor 52 detects a change in the distribution of the load applied to the seat. The occupant state determination component 129 determines that the occupant sitting on the driver's seat is in the state of having difficulty in continuing to drive when the length of the seat belt detected by the seat belt contact sensor 54 is larger than the length of the seat belt when the occupant does not fall forward (when the seat belt is extended further) or the distribution of the load to the seat detected by the seat load sensor 52 is different from the load distribution when the occupant does not fall forward (when the center of the distribution is on the front side of the seat). The state of having difficulty in continuing to drive is an example of a “predetermined state”.

The occupant state determination component 129 may determine that the occupant sitting on the driver's seat is in the state of having difficulty in continuing to drive when the steering contact sensor 56 detects that the occupant has not touched the steering wheel for a predetermined period or longer.

Even when the occupant state determination component 129 determines that the occupant sitting on the driver's seat is in the state of having difficulty in continuing to drive and the primary switch 12 is not operated, the throttle closing control component 118 controls the throttle actuator 60 to put the throttle opening into a fully closed state, the braking amount-determining component 120 determines a braking amount for stopping the subject vehicle and controls the brake actuator 62 according to the determined braking amount, the steering assist amount-determining component 122 determines a steering assist amount for guiding the subject vehicle to the target position and controls the steering actuator 64 according to the determined steering assist amount, and the hazard lamp blinking instruction component 124 operates the hazard lamp 70 continuously as the autonomous emergency stop control.

### [Process Flow]

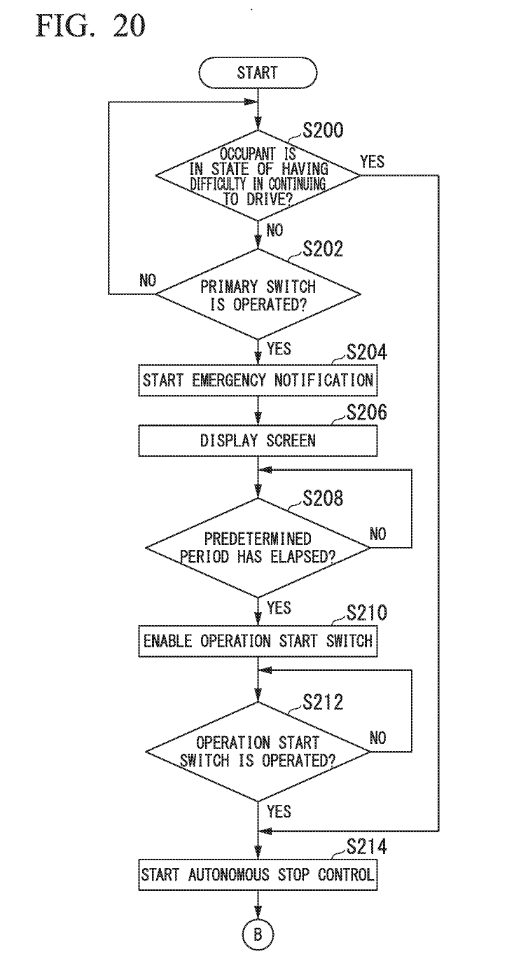

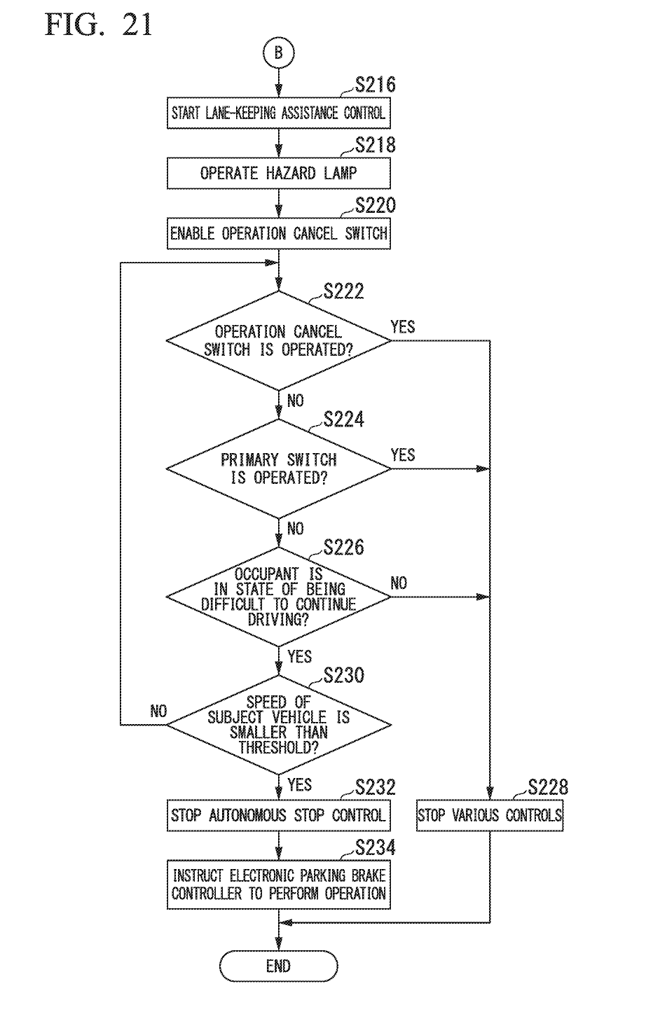

Hereinafter, the flow of a series of processes executed by the driving assistance device 100A according to the second embodiment will be described. FIGS. 20 and 21 are flowcharts illustrating the flow of a series of processes executed by the driving assistance device 100A according to the second embodiment. Since steps S202 to S224 and steps S228 to S234 of this flowchart are the same processes as steps S100 to S122 and steps S124 to S130 of the flowchart illustrated in FIGS. 16 and 17, the description thereof will be omitted.

First, the occupant state determination component 129 determines whether the occupant sitting on the driver's seat is in a state of having difficulty in continuing to drive (step S200). When the occupant state determination component 129 determines that the occupant sitting on the driver's seat is in the state of having difficulty in continuing to drive, the driving assistance device 100A proceeds to step S214 to be described below.

On the other hand, when the occupant state determination component 129 determines that the occupant sitting on the driver's seat is not in the state of having difficulty in continuing to drive, the output control component 112 proceeds to step S202.

When it is determined in step S224 that the primary switch 12 is not operated, the occupant state determination component 129 of the autonomous emergency stop controller 110A determines whether the occupant sitting on the driver's seat is in the state of having difficulty in continuing to drive (step S226).

When it is determined that the occupant sitting on the driver's seat is not in the state of having difficulty in continuing to drive, the autonomous emergency stop controller 110A proceeds to step S228.

On the other hand, when it is determined that the occupant sitting on the driver's seat is in the state of having difficulty in continuing to drive, the vehicle stop-determining component 126 of the autonomous emergency stop controller 110A proceeds to step S230.

In the second embodiment described above, although the starting condition of the autonomous emergency stop control is that the primary switch 12 and the operation start switch 13 are operated or that it is determined that the occupant sitting on the driver's seat is in the state of having difficulty in continuing to drive on the basis of the image captured by the occupant-monitoring camera 50, the present invention is not limited thereto. For example, the condition may further include a condition that the brake switch 40 is operated. For example, when the subject vehicle is not in the stopping state (the speed of the subject vehicle is equal to or larger than the stop determination threshold Vstp) and it is determined that the brake switch 40 is operated and that the occupant is in the state of having difficulty in continuing to drive, the operation instruction component 128 of the autonomous emergency stop controller 110 instructs the electronic parking brake controller 170, which is originally scheduled to operate, to stop operating in response to the operation on the brake switch 40. As a result, the electronic parking brake controller 170 does not start the electronic parking brake control but maintains a state in which the function is stopped. On the other hand, the autonomous emergency stop controller 110 starts the autonomous emergency stop control. Due to this, even when the occupant cannot extend his or her hands up to the primary switch installed on the interior roof due to reasons such as a worsening physical condition, for example, the occupant can start the autonomous emergency stop control by operating the brake switch 40 on the side surface of the driver's seat. Moreover, since it is determined whether or not to start the autonomous emergency stop control from the two viewpoints including the occupant's state determined based on image processing and the operation on the brake switch 40, for example, even when the brake switch 40 is erroneously operated by an occupant on a seat different from the driver's seat, the autonomous emergency stop control is not started unless the occupant on the driver's seat is in the state of having difficulty in continuing to drive.

According to the second embodiment described above, even when the operation start switch 13 is not operated, when the occupant state determination component 129 determines that the occupant sitting on the driver's seat is in the state of having difficulty in continuing to drive, the autonomous emergency stop controller 110 can decelerate the vehicle in the event of an emergency after suppressing erroneous operations of the occupant since the subject vehicle is decelerated until the speed of the subject vehicle becomes smaller than the stop determination threshold Vstp similarly to the first embodiment.

### <Hardware Configuration>

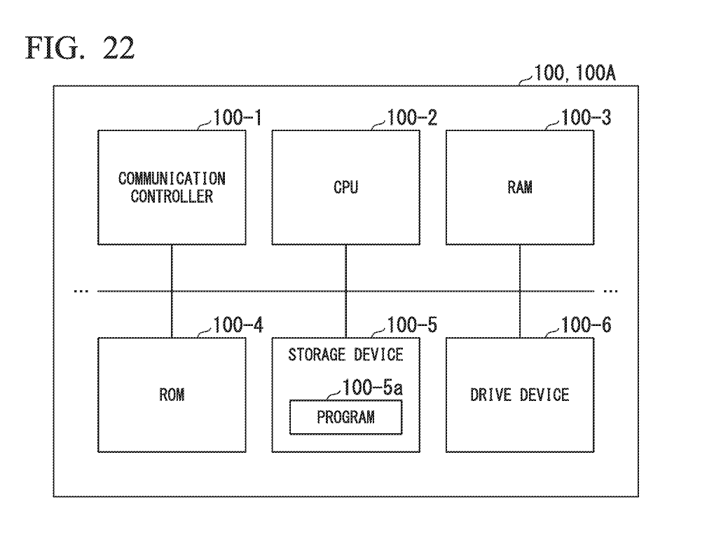

The driving assistance devices 100 and 100A according to the above-described embodiments are realized by such a hardware configuration as illustrated in FIG. 22, for example. FIG. 22 is a diagram illustrating an example of a hardware configuration of the driving assistance devices 100 and 100A according to the embodiments.

The driving assistance devices 100 and 100A have a configuration in which a communication controller 100-1, a CPU 100-2, a RAM 100-3, a ROM 100-4, a secondary storage device 100-5 such as a flash memory or a HDD, and a drive device 100-6 are connected to each other via an internal bus or a dedicated communication line. A portable storage medium such as an optical disc is mounted on the drive device 100-5. The autonomous emergency stop controller 110, the lane-keeping assistance controller 130, the adaptive cruise assistance controller 150, and the electronic parking brake controller 170 are realized when a program 100-5a stored in the secondary storage device 100-5 is loaded into the ROM 100-3 by a DMA controller (not illustrated) or the like and is executed by the CPU 100-2. The program referred to by the CPU 100-2 may be stored in a portable storage medium mounted on the drive device 100-6 or may be downloaded from other devices via a network NW.

The above-described embodiments may be expressed as follows.

In some embodiments, a driving assistance device may include a driving operator that receives a driving operation of an occupant, a first switch that receives an operation of the occupant, a second switch that receives an operation of the occupant after the first switch receives an operation of the occupant, and a control unit that decelerates a vehicle until the speed of the vehicle becomes smaller than a predetermined speed regardless of a driving operation on the driving operator when the second switch receives an operation of the occupant.

In some embodiments, a driving assistance device may include a first switch configured to be operated by an occupant, a second switch configured to be operated by the occupant, and a controller configured to decelerate a vehicle until the speed of the vehicle becomes smaller than a predetermined speed when the second switch is operated after the first switch is operated.

In some cases, the controller disables the second switch to be operated until a predetermined period has elapsed after the first switch is operated and enables the second switch to be operated after the predetermined period has elapsed.

In some cases, the driving assistance device may further include a touch panel configured to be operated by the occupant and display information, wherein the controller causes the touch panel to display information on the vehicle and display the second switch in a state in which an operation is enabled.

In some cases, the controller disables the second switch has display by the touch panel to be operated until a predetermined period has elapsed after the first switch is operated.

In some cases, the driving assistance device may further include a display configured to display information, wherein the controller causes the display to display information on the vehicle and display information indicating that an operation on the second switch is enabled after the first switch is operated.

In some cases, the controller decelerates the vehicle until the speed of the vehicle becomes smaller than the predetermined speed when the first switch is operated.

In some cases, a braking force applied to the vehicle associated with the process of decelerating the vehicle executed by the controller when the first switch is operated by the occupant is smaller than a braking force applied to the vehicle associated with the process of decelerating the vehicle executed by the controller when the second switch is operated by the occupant.

In some cases, the driving assistance device may further include a third switch configured to be operated by the occupant, wherein the controller disables the third switch to be operated before the second switch is operated, enables the third switch to be operated after the second switch is operated and stops a process of decelerating the vehicle when the third switch is operated.

In some cases, the controller starts steering control of controlling steering of the vehicle so as to maintain a traveling lane when the first switch is operated and continues the steering control even after the second switch is operated.

In some cases, the controller starts steering control of controlling steering of the vehicle so as not to depart a traveling lane when the first switch is operated and continues the steering control even after the second switch is operated.

In some cases, the driving assistance device may further include a fourth switch configured to be operated by the occupant, a braking mechanism that applies a braking force for stopping the vehicle to the vehicle, and an actuator configured to drive the brake mechanism when the fourth switch receives an operation of the occupant, wherein the controller decelerates the vehicle until the speed of the vehicle becomes smaller than the predetermined speed when the speed of the vehicle is equal to or larger than the predetermined speed and the fourth switch is operated.

In some cases, the driving assistance device may further include a camera configured to capture an image of the occupant, wherein the controller determines whether the occupant is in a predetermined state on the basis of the image generated by the camera and decelerates the vehicle until the speed of the vehicle becomes smaller than the predetermined speed when the occupant is in the predetermined state, the speed of the vehicle is equal to or larger than the predetermined speed, and the fourth switch is operated.

In some cases, the driving assistance device may further include a camera configured to capture an image of the occupant, wherein the controller determines whether the occupant is in a predetermined state on the basis of the image generated by the camera and decelerates the vehicle until the speed of the vehicle becomes smaller than the predetermined speed when the occupant is in the predetermined state.

In some embodiments, a driving assistance method for causing a computer mounted in a vehicle including a first switch configured to be operated by an occupant and a second switch configured to be operated by the occupant to execute, a process of decelerating the vehicle until the speed of the vehicle becomes smaller than a predetermined speed when the second switch is operated after the first switch is operated.

While aspects for carrying out the present invention have been described in the embodiments, the present invention is not limited to these embodiments, and various changes and substitutions can be made without departing from the spirit of the present invention.

What is claimed is:

1. A driving assistance device, comprising:
a first switch configured to receive an operation of an occupant;
a second switch configured to receive an operation of the occupant after the first switch receives an operation of the occupant;
a storage storing a program; and
a processor configured to execute the program stored in the storage, wherein
the storage stores the program that causes the processor to execute:
a process of decelerating a vehicle until the speed of the vehicle becomes smaller than a predetermined speed when the second switch receives an operation of the occupant.

2. The driving assistance device according to claim 1, wherein
the second switch is further configured to not receive an operation of the occupant until a predetermined period has elapsed after the first switch receives an operation of the occupant and receive an operation of the occupant after the predetermined period has elapsed.

3. The driving assistance device according to claim 1, further comprising:
a touch panel configured to display information, wherein
the storage stores the program that further causes the processor to execute:
a process of causing the touch panel to display information on the vehicle; and
a process of causing the touch panel to display the second switch in a state in which the switch receives an operation.

4. The driving assistance device according to claim 3, wherein
the storage stores the program that further causes the processor to execute:
a process of causing the touch panel to display the second switch in a state in which the switch does not receive an operation until a predetermined period has elapsed after the first switch receives an operation of the occupant.

5. The driving assistance device according to claim 2, further comprising:
a touch panel configured to display information, wherein
the storage stores the program that further causes the processor to execute:
a process of causing the touch panel to display information on the vehicle; and
a process of causing the touch panel to display the second switch in a state in which the switch receives an operation.

6. The driving assistance device according to claim 5, wherein
the storage stores the program that further causes the processor to execute:
a process of causing the touch panel to display the second switch in a state in which the switch does not receive an operation until a predetermined period has elapsed after the first switch receives an operation of the occupant.

7. The driving assistance device according to claim 1, further comprising:
a display configured to display information, wherein
the storage stores the program that further causes the processor to execute:
a process of causing the display to display information on the vehicle;
a process of causing the display to display information indicating that the second switch has entered into a state in which the switch receives an operation after the first switch receives an operation of the occupant.

8. The driving assistance device according to claim 2, further comprising:
a display configured to display information, wherein
the storage stores the program that further causes the processor to execute:
a process of causing the display to display information on the vehicle;
a process of causing the display to display information indicating that the second switch has entered into a state in which the switch receives an operation after the first switch receives an operation of the occupant.

9. The driving assistance device according to claim 1, wherein
the storage stores the program that further causes the processor to execute:
a process of decelerating the vehicle when the first switch receives an operation of the occupant.

10. The driving assistance device according to claim 9, wherein
a braking force applied to the vehicle associated with the process of decelerating the vehicle executed by the processor when the first switch receives an operation of the occupant is smaller than a braking force applied to the vehicle associated with the process of decelerating the vehicle executed by the processor when the second switch receives an operation of the occupant.

11. The driving assistance device according to claim 1, further comprising:
a third switch configured to not receive an operation of the occupant before the second switch receives an operation of the occupant and receive an operation of the occupant after the second switch receives an operation of the occupant, wherein
the storage stores the program that further causes the processor to stop execution of a process of decelerating the vehicle when the third switch receives an operation of the occupant.

12. The driving assistance device according to claim 1, wherein
the storage stores the program that further causes the processor to execute:
a process of starting steering control of controlling steering of the vehicle so as to maintain a traveling lane when the first switch receives an operation of the occupant; and
a process of continuing the steering control even after the second switch receives an operation of the occupant.

13. The driving assistance device according to claim 1, wherein
the storage stores the program that further causes the processor to execute:
a process of starting steering control of controlling steering of the vehicle so as not to depart a traveling lane when the first switch receives an operation of the occupant; and
a process of continuing the steering control even after the second switch receives an operation of the occupant.

14. The driving assistance device according to claim 1, further comprising:
a fourth switch configured to receive an operation of the occupant;
a braking mechanism that applies a braking force for stopping the vehicle to the vehicle; and
an actuator configured to drive the brake mechanism when the fourth switch receives an operation of the occupant, wherein
the storage stores the program that further causes the processor to execute:
a process of decelerating the vehicle until the speed of the vehicle becomes smaller than the predetermined speed when the speed of the vehicle is equal to or larger than the predetermined speed and the fourth switch receives an operation of the occupant.

15. The driving assistance device according to claim 14, further comprising:
a camera configured to capture an image of the occupant, wherein
the storage stores the program that further causes the processor to execute:
a process of determining whether the occupant is in a predetermined state on the basis of the image generated by the camera; and
a process of decelerating the vehicle until the speed of the vehicle becomes smaller than the predetermined speed when the occupant is in the predetermined state, the speed of the vehicle is equal to or larger than the predetermined speed, and the fourth switch receives an operation of the occupant.

16. The driving assistance device according to claim 1, further comprising:
a camera configured to capture an image of the occupant, wherein
the storage stores the program that further causes the processor to execute:
a process of determining whether the occupant is in a predetermined state on the basis of the image generated by the camera; and
a process of decelerating the vehicle until the speed of the vehicle becomes smaller than the predetermined speed when the occupant is in the predetermined state.

17. A driving assistance method for causing a computer mounted in a vehicle including a first switch configured to receive an operation of an occupant, a second switch configured to receive an operation of the occupant after the first switch receives an operation of the occupant, and a storage configured to store information to execute:
a process of decelerating the vehicle until the speed of the vehicle becomes smaller than a predetermined speed when the second switch receives an operation of the occupant.
